(19) United States
(12) Patent Application Publication
(10) Pub. No.: US 2025/0217685 A1
(43) Pub. Date: Jul. 3, 2025

(54) Universal Quantum Learning Device

(71) Applicant: Garen Musaelian, Sunny Isles Beach, FL (US)

(72) Inventor: Garen Musaelian, Sunny Isles Beach, FL (US)

(73) Assignee: Qognitive Inc., Miami Beach, FL (US)

(21) Appl. No.: 18/625,824

(22) Filed: Apr. 3, 2024

Related U.S. Application Data
(63) Continuation-in-part of application No. 18/597,309, filed on Mar. 6, 2024.
(60) Provisional application No. 63/527,386, filed on Jul. 18, 2023.

(51) Int. Cl. G06N 10/20

(52) U.S. Cl. CPC G06N 10/20

(57) ABSTRACT

A system and method for forecasting with a quantum subsystem using an artificial neural network (ANN) comprising: obtaining at least one data point and one or more stored parameters; mapping the at least one data point to one or more physical controls using the artificial neural network based on the one or more stored parameters; configuring the quantum subsystem at low temperatures based on the one or more physical controls; measuring generalized forces exerted on the quantum subsystem by the one or more physical controls; adjusting the one or more physical controls through the artificial neural network to lower energy of the quantum subsystem with respect to a training data set; and forecasting a missing data value in the data set to lower the energy of the quantum subsystem.

### TECHNICAL FIELD

The present invention relates to a system and method for a machine learning paradigm based on quantum cognition, and more particularly, relates to detecting a set of observables which can be captured by a real value or categorical variable and representing the variables as an operator in a Hilbert space for modeling correlations.

### BACKGROUND

### Interpretation Considerations

This section describes the technical field in detail and discusses problems encountered in the technical field. Therefore, statements in the section are not to be construed as prior art.

In mathematics, computer science, and engineering, a “combinatorial explosion” is the exponential dependence of computational and data requirements on the number of data features, and this phenomenon occurs when the number of possible combinations or configurations increases dramatically as the number of elements or variables involved in the system increases. The term “explosion” emphasizes the explosive growth that occurs, often overwhelming the computational resources and making it challenging to explore or analyze all the possible combinations within a reasonable time frame.

In classical computing, for example, consider the traveling salesman problem (TSP), where a salesman needs to visit a set of cities exactly once and return to the starting city, seeking the shortest possible route. As the number of cities increases, the number of possible routes to be considered for evaluation grows exponentially. This exponential growth in the number of possible solutions makes finding an optimal solution computationally demanding and often requires specialized algorithms or heuristics to approximate or find good solutions efficiently. Another example is in the domain of combinatorial optimization, where the goal is to find the best combination or arrangement of elements that optimizes a given objective function. Problems like the knapsack problem or the graph coloring problem exhibit combinatorial explosion as the number of items or nodes increases.

In the context of artificial intelligence and machine learning in classical computing, a combinatorial explosion occurs in tasks such as feature selection, where the number of possible feature combinations grows exponentially with the number of available features. Similarly, in language generation, large language models like GPT-3 are trained on vast amounts of text data and can generate coherent and contextually relevant text. However, when prompted with a specific task or query, the number of possible valid responses can be combinatorially large. The model must explore various combinations of words, phrases, and syntactic structures to generate an appropriate response. While language models can generate diverse outputs, finding the optimal or desired response among the combinatorially large space of possibilities can be challenging. Thus, combinatorial explosion leads to computational complexity, intensive resource requirements, and implementation practical feasibility challenges. Hence, there is an increased need for specialized algorithms and solutions overcoming potential limitations of classical computers and existing quantum systems on finding exact solutions.

In essence, the more factors a model has to consider, the more combinations of those factors exist, leading to an exponentially larger solution space. This rapid growth of complexity poses significant challenges to classical machine learning techniques, often hindering their performance and scalability.

One of the main contributing factors to this problem is high dimensionality. In machine learning, each feature or variable in the dataset adds another dimension to the problem. As the number of dimensions (features) grows, the number of possible combinations grows exponentially, creating an immense space that the algorithm must navigate. This issue, often termed as the “curse of dimensionality,” can significantly slow down the learning process and require a large amount of computational resources.

Another factor that exacerbates the combinatorial explosion is the complexity and variability of real-world data. The real world is inherently complex, with many interdependent and interacting variables. Capturing this in a dataset that a machine learning algorithm can learn from is inherently challenging, and achieving a model that generalizes well to unseen data is even more difficult. The dataset would need to be representative of the entire combinatorially large real-world scenario, which is practically impossible.

There is a void in the art and market for a solution to this combinatorial explosion problem, deviating from classical probability and set theories to achieve an exponential reduction in representational space. These models hold promise to deal with the vast number of variables and complex interdependencies in real-world data without succumbing to the combinatorial explosion problem.

### SUMMARY

The object is solved by independent claims, and embodiments and improvements are listed in the dependent claims. Hereinafter, what is referred to as “aspect”, “design”, or “used implementation” relates to an “embodiment” of the invention and when in connection with the expression “according to the invention”, which designates steps/features of the independent claims as claimed, designates the broadest embodiment claimed with the independent claims.

The present disclosure pertains to a viable solution to the combinatorial explosion problem can be found by employing quantum cognition models. These models, different from conventional probability and set theories, can exponentially compress the representational space.

In one aspect of the invention, the system utilizes quantum cognition for event prediction. This system comprises a processor, a non-transitory storage element, and encoded instructions. When these instructions are implemented by the processor, they enable the system to generate an operator that represents the observable in Hilbert Space with restricted parametrization. This operator aids in predicting an event based on a correlation between represented observables resulting from the manipulation of operators in Hilbert Space.

In one exemplary aspect, an operator generated by a module can aggregate all data at any specific data point. It means the operator represents the aggregate deviation of observable operators from observations at a specific data point. In this case, the operator includes a ground state that is computed on a classical or quantum computer to minimize the deviation of observable operators from a given data point's observations.

In a separate aspect of the invention, the system incorporates a probability or forecasting module that is configured to calculate the probability of an operator's outcome. This calculation is grounded on the squared norm of the state vector's projection onto the eigenstate. An expected value determination module is also included to calculate the expected value of any real valued observable by determining the corresponding operator's expected value in the ground state.

The disclosure also provides a training module designed to learn all operators using stochastic gradient descent implemented on a classical computer. This module can also establish gradient descent on a quantum computer as a ground state problem. The training module uses a specific training paradigm that involves Hilbert Space Expansion, Hilbert Space Pruning, and Hierarchical Learning.

Another object teaches a system that systematically expands, prunes, and learns from the Hilbert Space. Expansion increases the dimensionality of Hilbert Space, where all observable operators expand into a block diagonal form. Pruning reduces the dimensionality of the Hilbert Space by projecting all observable operators away from redundant dimensions. Hierarchical Learning involves separately learning groups of observables, then learning those groups collectively by applying the same rotations to all operators within each group.

In yet another aspect, a method for utilizing quantum cognition for event modeling is detailed. This method involves generating an operator representing the observable in Hilbert Space, and modeling a correlation between represented variables to deduce the probability of an event. This method further includes establishing a current state that corresponds to the ground state to minimize the description error.

Additional aspects include a method encompassing the steps of: generating an operator representing the observable in Hilbert Space, modeling a correlation between represented variables, and outputting a modeled event based on the modeled correlation. This method is mediated by a Quantum Cognition Modeling layer, QOG layer, or simply QOG, which comprises at least a generator module for generating an operator in Hilbert space for manipulation to predict events.

Exponential reduction in representational space, while retaining the ability to model correlations between represented variables is a key aspect and benefit of the present invention. This allows inference and decision making on large sets of variables without running into the problem of dimensionality and combinatorial explosion by encoding information into a Hilbert State Model (HSM), trained efficiently on classical hardware using an artificial neural network, for modeling correlations between represented variables.

The present disclosure pertains to a quantum system designed to encode data within its ground state through controlled manipulation of physical controls, facilitated by an artificial neural network (ANN), in coordination with a quantum subsystem operating at low temperatures. Notably, the primary advantage of this approach is its exemption from the necessity to compute or model the Error Hamiltonian, distinguishing it from conventional gate-based operations.

An object of the present invention is to provide a system and method for solving the combinatorial explosion problem.

An object of the present invention is to provide a system and method to represent multiple datasets in representational space to solve the problem of high dimensionality.

An object of the present invention is to provide a system and method for reducing the complexity, noise, errors, and resource requirements of the quantum-inspired techniques.

According to an aspect of the invention, the present invention provides a method for forecasting with a quantum subsystem using an artificial neural network (ANN) or any other parametrized function mapping data inputs to the values of physical controls, referred as ANN throughout the description. The method comprises the steps of: a) obtaining at least one data point and one or more stored parameters; b) mapping at least one data point to one or more physical controls using the ANN based on one or more stored parameters; c) annealing the quantum subsystem at low temperatures based on the one or more physical controls to its ground state; d) measuring generalized forces exerted on the quantum subsystem by the physical controls; e) adjusting the physical controls through the to lower the energy of the quantum subsystem with respect to the training data set by backpropagating the measured generalized forces through the; and f) forecasting a missing data value in the data set by lowering the energy of the quantum subsystem with respect to the missing values using backpropagation of the measured generalized forces through the ANN.

In an embodiment, according to the present invention, obtaining at least one data point includes observing values inputted by the user, received through a networked system, or determined using a sensor network.

In an embodiment, according to the present invention, mapping a data point to one or more physical controls using the ANN based on the one or more stored parameters implements digital to analog conversion.

In an embodiment, according to the present invention, mapping at least one data point to one or more physical controls using the ANN based on the one or more stored parameters includes generating electrode voltage, capacitances of capacitors connecting Cooper boxes, electrode current, or any output required to control the quantum subsystem.

In an embodiment, according to the present invention, obtaining at least one data point and mapping to one or more physical controls includes generating a series of physical controls as outputs from observables as input data points using a parametrized mapping method.

In an embodiment, according to the present invention, mapping at least one data point to one or more physical controls using the ANN based on the one or more stored parameters results in different output if the stored parameters inputted are changed.

In an embodiment, according to the present invention, configuring the quantum subsystem based on the one or more physical controls includes annealing of the quantum subsystem to a low temperature.

In yet another embodiment, according to the present invention, forecasting a missing data value in the data set to lower the energy of the quantum subsystem preferably implement gradient descent.

In yet another embodiment, according to the present invention, forecasting a missing data value in the data set to lower the energy of the quantum subsystem calculates the gradient with respect to missing data values by back-propagation (chain rule) of generalized forces.

In yet another embodiment, according to the present invention, forecasting a missing data value is assigning an expected value to a missing observable.

According to another aspect of the invention, the present invention provides a method for training a quantum subsystem. The method comprises the steps of: a) obtaining a dataset and feeding at least one data point at a time to an artificial neural network (ANN); b) mapping the dataset to one or more physical controls in the quantum subsystem using the ANN; c) configuring the quantum subsystem at low temperatures based on the one or more physical controls; d) measuring generalized forces exerted on the quantum subsystem by the one or more physical controls; e) adjusting the one or more physical controls through the ANN to lower the energy of the quantum subsystem using gradient descent, where gradients are calculated by backpropagating the measured generalized forces through the ANN; and f) storing the adjusted parameters of the ANN to input into the quantum subsystem for forecasting.

According to another aspect of the present invention, the present invention provides a system for forecasting in a quantum subsystem using an artificial neural network (ANN). The system comprises at least one processor, the ANN, a digital-to-analog converter, and the quantum subsystem. The at least one processor receives and stores a dataset. The ANN maps the dataset to one or more physical controls. The digital-to-analog converter translates the digital output of the ANN to a physical value of the one or more physical controls. The quantum subsystem forecasts a missing data value.

In an embodiment, according to the present invention, the at least one processor receives the data set from a user or at least one connected device and stores the dataset into a memory device.

In an embodiment, according to the present invention, the memory device includes one or more registers to store the at least one data point of the data set for feeding into the ANN.

In an embodiment, according to the present invention, the quantum subsystem to forecast a missing data value comprises a module to extract one or more parameters from dataset during a training iteration to store in the memory device.

Other aspects and benefits of the invention will be apparent from the following description and the attached claims. The OOG framework and QOG Universal Learning Device represent a pioneering step in quantum computing, utilizing machine learning (ML) through the lens of quantum probability theory. This innovative approach contrasts sharply with traditional ML models that are built upon classical probability theory-plagued by the curse of dimensionality.

Other aspects and advantages of the invention will be apparent from the following description and the appended claims.

### BRIEF DESCRIPTION OF THE DRAWINGS

Various aspects and embodiments of the present invention are better understood by referring to the following detailed description. In order to better appreciate the advantages and objects of the embodiments of the present invention, reference should be made to the accompanying drawings that illustrate these embodiments.

The drawings illustrate the design and utility of embodiments of the present invention, in which similar elements are referred to by common reference numerals. In order to better appreciate the advantages and objects of the embodiments of the present invention, reference should be made to the accompanying drawings that illustrate these embodiments. However, the drawings depict only some embodiments of the invention, and should not be taken as limiting its scope. With this caveat, embodiments of the invention will be described and explained with additional specificity and detail through the use of the accompanying drawings in which:

FIG. 1A illustrates an exemplary network diagram of the quantum cognition (QOG) framework according to an embodiment of the invention.

FIG. 1B illustrates an exemplary system diagram of the QOG framework according to an embodiment of the invention.

FIG. 2 illustrates an exemplary system diagram of the QOG framework according to an embodiment of the invention.

FIG. 3 illustrates an exemplary system diagram of the QOG framework according to an embodiment of the invention.

FIG. 4 illustrates an exemplary flow diagram of the QOG framework according to an embodiment of the invention.

FIG. 5 illustrates a method flow diagram of the QOG framework according to an embodiment of the invention.

FIG. 6 illustrates an exemplary system diagram in accordance with an aspect of the invention.

FIG. 7 illustrates a functional diagram of training with a quantum subsystem using an artificial neural network in accordance with an exemplary embodiment of the present invention.

FIG. 8 illustrates a functional diagram of forecasting with a quantum subsystem using an artificial neural network in accordance with an exemplary embodiment of the present invention.

FIG. 9 illustrates an interaction between a quasi-classical system and a quantum subsystem in accordance with an exemplary embodiment of the present invention.

FIG. 10 illustrates a diagram of a quasi-classical layer of an quantum subsystem at low temperature in accordance with an exemplary embodiment of the present invention.

FIG. 11 illustrates a diagram of quantum dots controlled by electrodes with variable voltages accordance with an exemplary embodiment of the present invention.

FIG. 12 illustrates a method for forecasting an observable with a quantum subsystem in accordance with an exemplary embodiment of the present invention.

FIG. 13 illustrates a method for forecasting an observable using a quantum subsystem comprising a quantum a dot-based quantum layer in accordance with an exemplary embodiment of the present invention.

FIG. 14 illustrates a method for forecasting an observable using a quantum subsystem comprising trapped ions in accordance with an exemplary embodiment of the present invention.

FIG. 15 illustrates a method for forecasting an observable using a quantum subsystem comprising Cooper Boxes in accordance with an aspect of the invention.

FIG. 16 illustrates a method for forecasting an observable using a quantum subsystem comprising Optical Lattice in accordance with an aspect of the invention.

### DETAILED DESCRIPTION

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described. A function or an act should be interpreted as incorporating all modes of performing the function or act unless otherwise explicitly stated. The use of the word “observable”, “data points” and all other species of this word and similar words such as “dataset” are interchangeably used throughout the description.

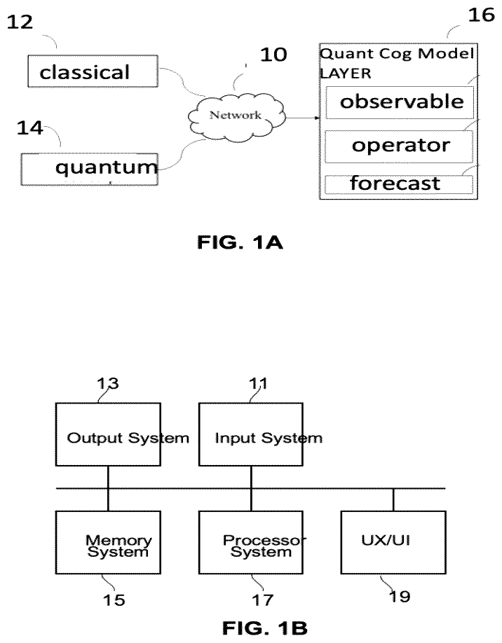

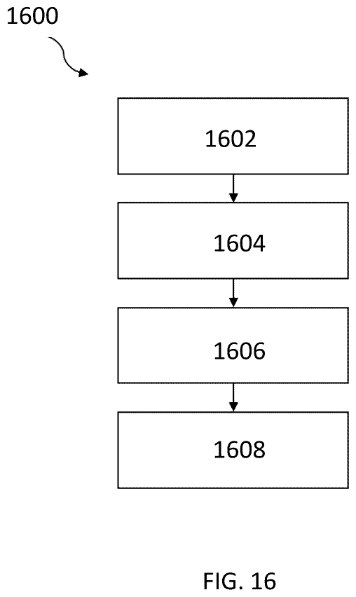

Specific embodiments of the invention will now be described in detail with reference to the accompanying FIGS. 1-16. In the following detailed description of embodiments of the invention, numerous details are set forth in order to provide a thorough understanding of the invention. In other instances, well-known features have not been described in detail to avoid obscuring the invention

The figures illustrate the architecture, functionality, and operation of possible implementations of systems, methods, and computer program products according to various embodiments of the present invention. It should also be noted that, in some alternative implementations, the functions noted/illustrated may occur out of order. For example, two blocks shown in succession may, in fact, be executed substantially concurrently, or the blocks may sometimes be executed in the reverse order, depending upon the functionality involved.

Since various possible embodiments might be proposed of the above invention and amendments might be made in the embodiments above set forth, it is to be understood that all matter herein described or shown in the accompanying drawings is to be interpreted as illustrative and not to be considered in a limiting sense. Thus, it will be understood by those skilled in the art that although the preferred and alternate embodiments have been shown and described in accordance with the Patent Statutes, the invention is not limited thereto or thereby.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification do not necessarily refer to the same embodiment, nor are separate or alternative embodiments mutually exclusive of other embodiments. Moreover, various features are described, which may be exhibited by some embodiments and not by others. Similarly, various requirements are described, which may be requirements for some embodiments but not all embodiments.

In a preferred embodiment, the system is designed to infer the probability of an event by modeling a correlation between represented variables. It uses the encoded operator and the learned ground state, giving the system the ability to understand and predict correlations between different variables. In yet another embodiment, the generating module leverages a specific training paradigm involving Hilbert Space Expansion, Hilbert Space Pruning, and Hierarchical Learning. These techniques allow the system to manage exceptions, optimize learning, and train groups of operators both separately and together, enabling effective event forecasting based on quantum cognition principles. These steps underpin a novel quantum machine learning paradigm (QOG Framework), where correlations in high-dimensional Hilbert spaces can capture complex relationships in the data. The modeling and inference involve quantum principles, providing an avenue for a logarithmic economy of representation and holistic inference, potentially yielding applications in finance, large language models, robotics, healthcare, and more

The QOG Framework and the QOG Universal Learning Device form a cutting-edge quantum computing system that utilizes machine learning based on quantum probability theory, diverging from traditional models based on classical probability. This system comprises a processor and storage element that together execute encoded instructions to generate an operator in Hilbert Space with restricted parameterization. These operators are then manipulated to forecast events by establishing a correlation between observables. The system may also include mapping data points to physical controls and configuring a quantum subsystem annealed at low temperatures to measure and adjust forces, using back-propagation and gradient descent to train a model with predictive accuracy.

This novel quantum-based machine learning paradigm provides a logarithmic economy of representation and enables holistic inference—avoiding the classical M.L. limitation of dimensionality and combinatorial explosion—by encoding observables as an operator in a Hilbert state model by a QOG Layer or generating module for downstream manipulation for modeling or forecasting an event. It can be implemented on existing quantum and/or classical hardware and combined with classical machine learning techniques. Its applications can range from financial products to large language models, robotics, logistics, manufacturing, drug discovery, healthcare, and beyond.

### Glossary

Observables and Wave-Packet State: In the QOG pipeline, observables are represented as operators on Hilbert space. The Error Hamiltonian, a defining operator that highlights deviation from given data, formulates the wave-packet state. This state corresponds to specific data points, but the encoding isn't precise.

Wave Packet and Uncertainty: Heisenberg's Uncertainty Principle governs the quantum behavior of particles, with the uncertainty being minimized at a wave-packet state.

Hilbert Space Models: The Hilbert Space is where observables, represented as operators, act. Each incomplete data point can be considered as a projection on this space. The classical limit of this model corresponds to a high-dimensional Hilbert space with all operators mutually commutative.

Inference: Using observations for a set of operators, the QOG pipeline finds the corresponding wave-packet state. The probability of an outcome for an operator is determined, as well as the expected value of that operator.

Training: The QOG pipeline trains the model by learning all operators, with the learning process guided by stochastic gradient descent (SGD). This method can be employed on both classical and quantum computers.

Specific Training Paradigm: The pipeline encompasses techniques like Hilbert Space Expansion (for handling exceptions and poorly trained data), Hilbert Space Pruning (to remove the lowest weighted modes), and Hierarchical Learning (for training groups of operators separately and together).

Relevance Realization: The system integrates low-energy inputs (that fit into context) and gives higher significance to high-energy inputs (that conflict with context).

Example—Commutative Operators: The system can learn to forecast certain variables given a set of inputs, even when classical methods like linear regression fail. The QOG pipeline, with quantum representation, can address this problem efficiently.

Example—Binary Observables: The pipeline can handle high-dimension scenarios and retain some forecasting ability even when the dimensionality of the Hilbert Space drops below 16.

Artificial Neural Network (ANN): A parametrized continuous differentiable mapping function between inputs and outputs. In our case, it maps observable inputs into controls in a parametrized continuous differentiable way, whereby the parameters of the mapping are learned through gradient descent as outlined.

Quantum Subsystem: a many-body physical system at low temperature exhibiting quantum behavior due to the fact that the temperature is low compared to the gaps of the energy spectrum of the system.

Annealing: the process of trapping the system in its ground state by gradual decrease of temperature.

Physical Controls: external devices that calibrate physical parameters of the quantum subsystem through controllable physical quantities. For example, an electrode exerting an electric field on the quantum subsystem is calibrated by the voltage applied to the electrode.

Generalized Force: also known as susceptibility, generalized force equals the derivative of the energy of the quantum subsystem with respect to the value of the physical control (e.g. voltage) and can be measured by the macroscopic effect that the quantum subsystem exerts on the physical control, such as induced currents, charges, magnetic fields, etc.

Back-Propagation: in machine learning, application of the chain rule to calculate the gradient of the loss function with respect to a set of parameters.

Gradient Descent: in machine learning, incremental change of parameters in the direction of steepest descent, i.e. incrementing all parameters by the quantity corresponding to the gradient of the loss function with

### EXEMPLARY ENVIRONMENT

FIG. 1A illustrates an exemplary network diagram of the Quantum Cognition Modeling Framework, or Machine-Learning Paradigm based on Quantum Cognition, or simply QOG Framework (QOG)—networked and configured for achieving the ultimate objective of providing a quantum cognition approach for modeling or forecasting an event. In other words, the QOG generates an operator encoded from a set of observables, with modules that communicatively couple to an actor, which can be either an intelligent agent or any user interacting with the system. The system also includes classic computing systems 12, a quantum computing model 14, a processor, and a non-transitory storage element connected to the processor. Encoded instructions in the storage element, when executed, enable the system to generate a Hamiltonian operator, representing the observable in Hilbert Space with a restricted parametrization, and forecast an event based on a correlation between the represented observables. With respect to QOG, mediated by a quantum computing model, we achieve a precise and efficient method of event forecasting.

In continuing reference to the network diagram of FIG. 1A, the network referenced as 10 is communicatively coupled to the QOG 16, and further coupled to a quantum computing model 14. The QOG comprises at least one module configured to communicatively couple with an actor, wherein said actor is at least one of an intelligent agent and a user, and at least one module configured to communicatively couple with any one of a quantum computing model; a processor; a non-transitory storage element coupled to the processor; encoded instructions stored in the non-transitory storage element, wherein the encoded instructions when implemented by the processor, configure the system to generate an operator, representing the observable in Hilbert Space with a restricted parameterization, and forecast an event based on the represented observables.

The network architecture supporting the QOG is not limited to any specific type of network. The network 10 can be any suitable wired or wireless network, or a combination of both. It may include LAN or wireless LAN connections, Internet connections, point-to-point connections, or any other network connection. The network 10 can transmit data between host computers, personal devices, mobile phone applications, video/image capturing devices, video/image servers, or any other electronic devices. It can be a local, regional, or global communication network, including enterprise telecommunication networks, the Internet, global mobile communication networks, or any combination of similar networks. The network 10 can also include software, hardware, or computer applications that facilitate the exchange of signals or data in any format known in the art, related art, or developed in the future. If the network 10 includes both an enterprise network and a cellular network, suitable systems and methods are employed to seamlessly communicate between the two networks. For instance, a mobile switching gateway may be used to communicate with a computer network gateway to pass data between the two networks.

FIG. 1B visually represents the standard bus architecture employed in the QOG system, a novel approach to handling high-dimensionality problems and complex interdependencies in data modeling, common in the field of AI and machine learning. The bus diagram serves as an illustrative tool, mapping the intricate connectivity of system components, which are collectively responsible for addressing the combinatorial explosion issue.

In this conventional bus topology, the main communication highway, often referred to as the “bus,” connects all key components of the QOG system, including the memory system 15, processor system 17, input system 11, output system 13, and a User Experience/User Interface (UX/UI) system 19. Each of these components are interlinked via the bus, enabling the sharing of data, instructions, and resources, which is vital for system performance.

The memory system 15, one of the vital nodes connected to the bus, is crucial for the storage and retrieval of data and encoded instructions. In this bus environment, when the processor system 17 retrieves and executes these instructions from the memory system 15, it configures the QOG system to undertake a variety of operations, such as generating an operator and modeling an event based on the represented observables.

The input system 11, another critical component attached to the bus, is utilized to receive input data, effectively initializing the QOG Framework. Conversely, the output system 13, also connected to the bus, displays the results of the QOG operations in an easy-to-understand, human-like interaction format. The data flow from input to processing to output is facilitated via the bus, illustrating the interconnectivity and data exchange amongst these components.

The UX/UI system 19, connected to the bus, acts as a user-facing component, offering an intuitive and interactive interface for users to engage with the QOG system. This aids in understanding the presented output and interacting with the system using human-like interactions.

The bus diagram, in essence, is not just a visualization tool, but a fundamental map that demonstrates the operational flow of the QOG system. It allows stakeholders to understand how the system works, how components interact, and where data flows. By highlighting the interconnectedness and cooperation of the QOG components, the bus diagram is instrumental in visualizing how the system addresses the combinatorial explosion problem and optimizes the performance of AI/ML models.

### EXEMPLARY PROCESS

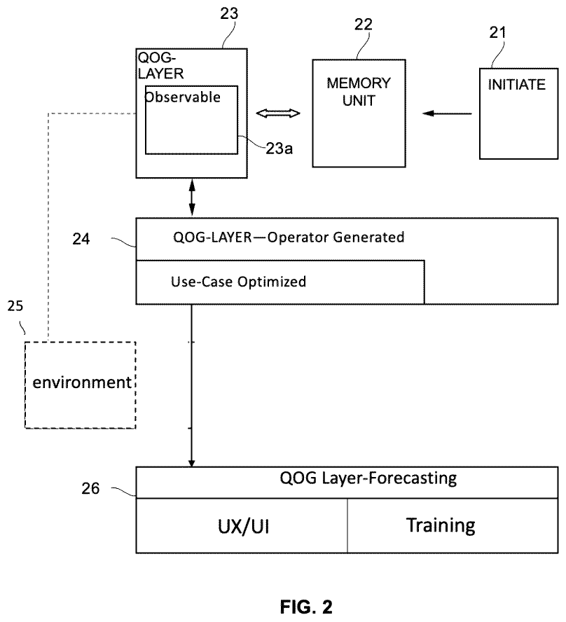

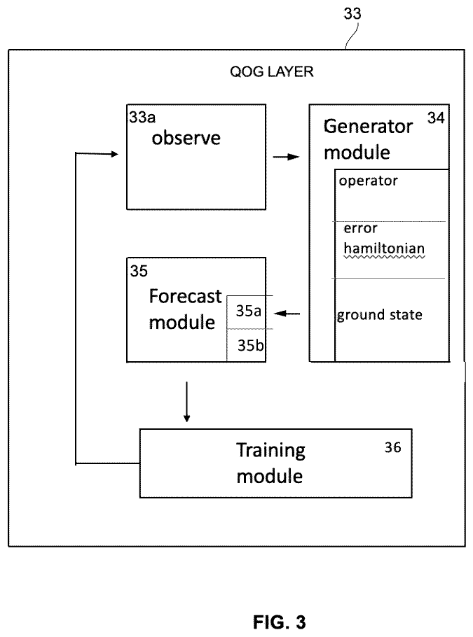

Now, referring to FIG. 2 and FIG. 3, these figures illustrate an exemplary system flow diagram in harmony with an aspect of the invention. FIG. 2 provides an overview of the global system interaction, while FIG. 3 dives into the details of the processor, revealing individual modules within and interactions among them.

In particular, FIG. 2 presents a block diagram of the system that includes an initiation event 21, a memory unit 22 in communication with the initiation event 21, and a processor 23. This processor is in communication with the memory unit 22 and encompasses or interacts with an Observable Module 23a, a Generator Module 24, Environmental (Contextual) Module 25, and an Interface Layer Module 26. In an embodiment, the memory unit 22 is a non-transitory storage element storing encoded information. These encoded instructions, when implemented by the processor 23, configure the system to generate an operator that represents an observable in Hilbert Space (HSM) and forecast an event based on a correlation between the represented observables as a result of manipulating the operators in the HSM.

FIG. 3 offers a detailed view of the processor's internal operations, focusing specifically on the generator module 34. This module performs a series of complex operations to encode the observable for eventually generating an operator to correspond to the observable in the Hilbert Space. These operations involve observing the data, encoding the data into an operator, and modeling an event based on the represented observables in Hilbert Space. The module then maps these correlations onto the forecasted events, resulting in an output event that has been predicted based on the manipulation of operators within Hilbert Space.

In continuing reference to FIGS. 2 and 3, one embodiment of the system reveals that the Generator Module 24 functions to create an Hamiltonian operator by aggregating all of the data at any given data point or point in time. As such, the Error Hamiltonian is able to represent the aggregated deviation of observable operators from observations of a given data point.

Moreover, as part of its operation, the Generator Module 34 may also compute a ground state of the Error Hamiltonian, either on a classical or a quantum computer. This ground state generation aims to minimize the aggregated deviation of observable operators from observations of a given data point. This ground state can be thought of as finding a state with a smaller vector that can represent an entire image or dataset. While it may not represent the data exactly, the system can ask questions about the state of representation and the accuracy of the representation. It should be noted that in traditional quantum computing, information is often lost when a second variable is observed; however, this methodology ensures the preservation of previous information, even as new variables are observed.

In a further embodiment, in continuing reference to FIG. 3, the system also comprises a Probability Determination Module 35a and an Expected Value Determination Module 35b. The Probability Determination Module 35a is configured to calculate the probability of an outcome for any operator, which is given by the squared norm of the projection of the state vector onto the eigenstate. On the other hand, the Expected Value Determination Module 35b is designed to calculate the expected value of any real-valued observable by determining the expected value of the corresponding operator in the ground state.

Further interaction within the Quantum Cognition Layer 33 in FIG. 3 showcases a Training Module 36. This module is designed to learn all operators, up to an arbitrary rotation, using stochastic gradient descent implemented on a classical computer. It can also formulate gradient descent on a quantum computer as a ground state problem. This training module is particularly adept at employing specific training paradigms involving Hilbert Space Expansion, Hilbert Space Pruning, and Hierarchical Learning.

In the context of Hilbert Space Expansion, the Training Module 36 increases the dimensionality of the Hilbert Space where all observable operators are expanded into a block-diagonal form consisting of old and new dimensions. During Hilbert Space Pruning, the module reduces the dimensionality of Hilbert Space by projecting all observable operators away from redundant dimensions. Hierarchical Learning involves learning groups of observables separately and then collectively applying the same rotations to all operators within each group.

Finally, the Training Module 36 can accommodate exceptions and sub-trained data by adding new dimensions as part of Hilbert Space Expansion, removing the lowest-weighted modes as part of Hilbert Space Pruning, training groups of operators separately then together on the same Hilbert Space to learn optimal rotations between groups, and multiplying two Hilbert Spaces into a larger Hilbert Space, then conducting training through Stochastic Gradient Descent and Pruning.

While not shown in FIG. 2 and FIG. 3, there are additional components and processes integral to the implementation of the system for quantum cognition-based forecasting. In one embodiment, the system includes a means for detecting an observable, which can be any input or output that can be captured by a binary or any value. The observed data is then passed to the generator module for generating an operator for correspondence in Hilbert space.

In another embodiment, the system comprises a correlation modeling module. This module models a correlation between represented variables, allowing for an enhanced understanding of the relationships within the data. This information is particularly valuable in forecasting an event based on the correlations identified.

In an additional embodiment, a unique training paradigm is applied, known as Hilbert Space Expansion, Hilbert Space Pruning, and Hierarchical Learning. As part of Hilbert Space Expansion, new dimensions are added to fit exceptions and sub-trained data exactly. During the Pruning phase, the system removes the lowest weighted modes, thereby effectively reducing any redundancy within the data. As part of Hierarchical Learning, the system trains groups of operators separately, then together on the same Hilbert Space to learn optimal rotations between groups. This intricate process multiplies two Hilbert spaces into a larger Hilbert space, then employs training through Stochastic Gradient Descent and Pruning.

Moreover, the system may also involve an output module. This module's functionality includes outputting a modeled event based on the modeled correlation. It leverages the information processed and correlations identified within the system to yield meaningful predictions or forecasts, thereby making it an essential component in the context of quantum cognition-based event forecasting.

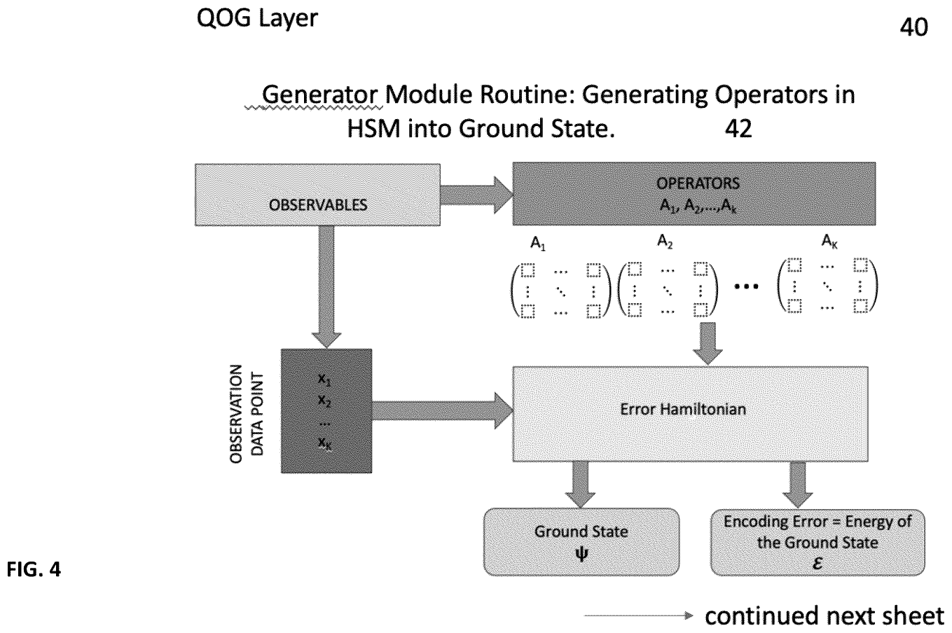

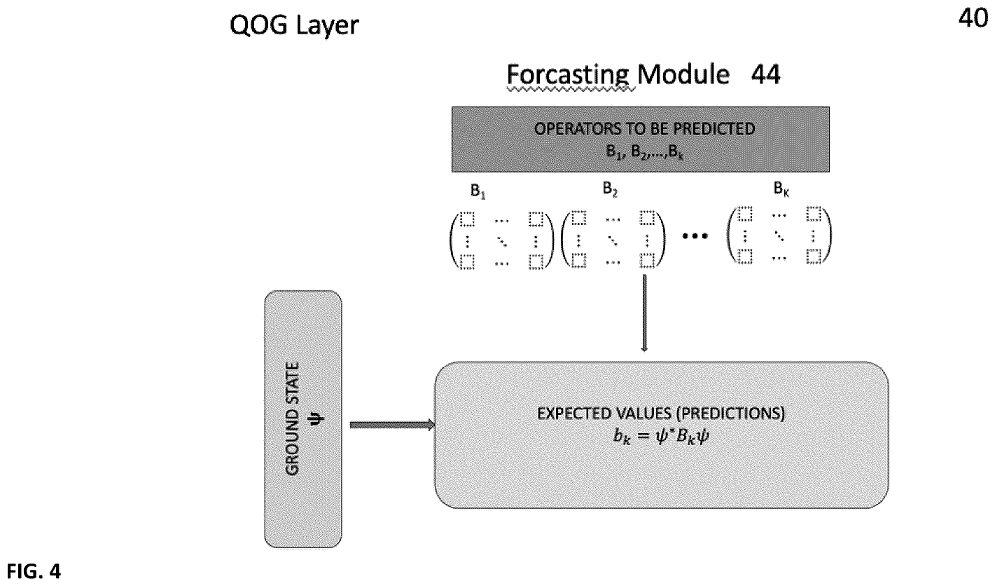

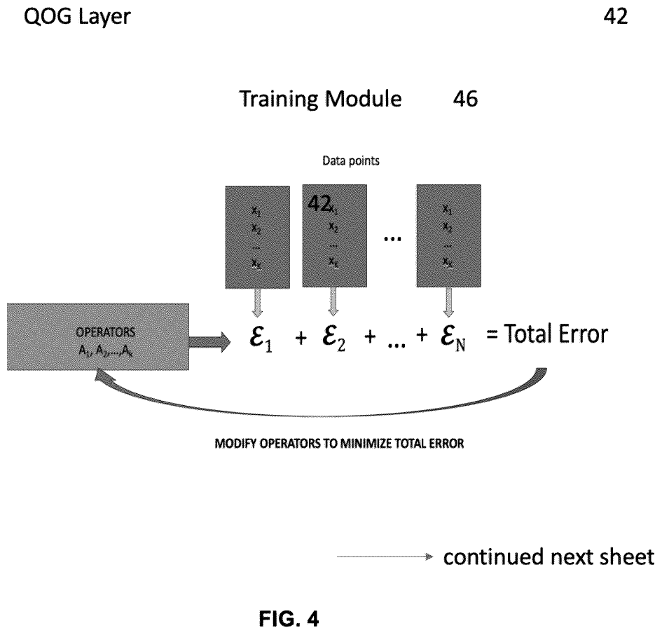

FIG. 4 represents a high-level schematic of an exemplary QOG environment and process. In one embodiment, the process initiates with a deep comprehension of observables as operators in a Hilbert space. Observables, represented as Aₖ, are measurements intrinsic to the quantum system and can denote variables such as position, momentum, energy, spin, and more. Each observable uniquely defines an aspect of the quantum system, thereby forming a foundational premise for the subsequent modeling and inference stages of the QOG pipeline.

The Error Hamiltonian, in a specific embodiment, acts as a cornerstone for the measurement of data deviations. It is realized as an operator that quantifies discrepancies between the predicted and actual data points, denoted as y′=yₖ′. The Error Hamiltonian

$${H}_{t} = {\sum }_{k} \frac{1}{2 {σ}_{k}^{2}} {( {A}_{k} - {x}_{k}^{t} )}^{2}$$

considers each operator in the Hilbert space and computes the squared deviation from each data point, providing a crucial measure of the quantum model's accuracy.

In another embodiment, the wave-packet state, or the quantum state, is denoted as |Ψ⁻t. The wave-packet state reflects a superposition of various eigenstates, and it adheres to a data point y t=yk t. Despite this adherence, the data point is not perfectly encoded due to the inherent uncertainty principle in quantum mechanics, commonly known as Heisenberg's uncertainty principle

$$( Δ x Δ p \geq \frac{ℏ}{2} ( ) ) .$$

This principle establishes the inescapable compromise between the precision of concurrent measurements of complementary variables in the quantum system.

The QOG pipeline's next phase, as portrayed in FIG. 4, incorporates modeling, inference, and training. In the modeling phase, Hilbert space models are constructed with the observables defined as operators in this space. Every incomplete data point contributes a unique projection in the Hilbert space that aligns with the corresponding incomplete data point. Classical limits and goodness of fit measurements are two critical parameters that evaluate the model's success in this phase.

Following modeling is the inference phase. In this context, the inference process includes the determination of a corresponding wave-packet state |Ψ⁻ from given observations xk for a set of operators Aₖ. The wave-packet state thus inferred serves to compute the probability of outcome j for any other operator Bₖ.

The next stage, the training phase, revolves around learning all operators. Techniques such as stochastic gradient descent (SGD) are employed for learning operators, which can be executed on a classical computer. An alternative approach involves implementing gradient descent on a quantum computer, which is formulated as a ground state problem.

As we proceed further in the pipeline, the focus shifts to specific training paradigms such as Hilbert Space Expansion/Exceptions, Hilbert Space Pruning, and Hierarchical Learning. The concept of expansion and exceptions addresses the dimensionality and coverage of the Hilbert space, introducing more quantum states to cover all potential outcomes and exceptions to address outliers.

Hilbert Space Pruning, on the other hand, is the process of simplifying the Hilbert space model by removing or reducing certain dimensions, a procedure analogous to feature selection in classical machine learning. Hierarchical Learning involves the sequential training of operator groups, promoting a more refined and efficient learning process by focusing on subsets of operators rather than the entire operator space.

The final stage of the QOG pipeline, as depicted in FIG. 4, is the Relevance Realization phase. Here, inputs that align with the established context are incorporated and subsequently omitted for further analysis. Contrastingly, inputs that are discordant with the context are intensely scrutinized, measured, and assigned a valence.

This comprehensive QOG pipeline, as elucidated in FIG. 4, effectively integrates quantum mechanics and Hilbert state models to bring forward a new paradigm in various fields such as finance, large language models, robotics, healthcare, and more. The invention, rooted in deep learning and quantum cognition, is poised to address the challenges in traditional machine learning and data analysis algorithms, thereby contributing to the evolution of quantum machine learning.

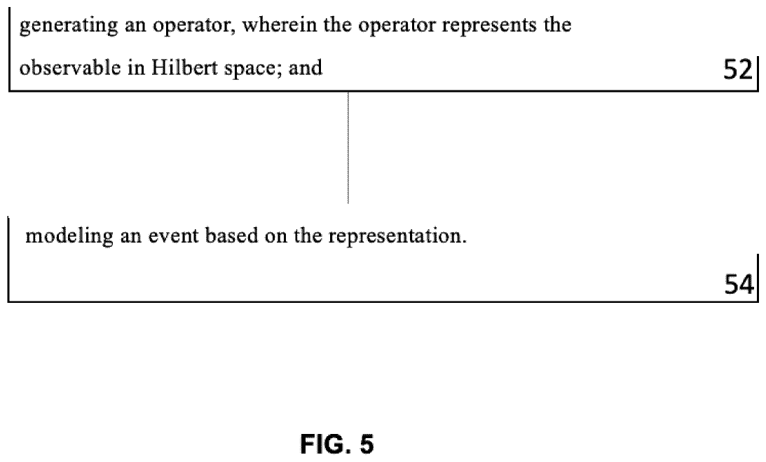

Now in reference to FIG. 5, which illustrates an exemplary method flow diagram in accordance with an aspect of the invention, entailing a method for forecasting an event based on an encoding of an observable in a Hilbert state model. The method entails the steps of: FIG. 5, focusing on the two steps: generating an operator, and modeling an event based on the observable-corresponding operators to deduce the probability of the event.

### Step 1: Generating an Operator

In this step, an operator is generated which represents the observables within the Hilbert Space. Observables are physical quantities that can be measured, and each observable corresponds to a specific operator in quantum mechanics. The error Hamiltonian operator. defined as

$${H}_{t} = {\sum }_{k} \frac{1}{2 {σ}_{\text{?}}^{2}} {( {A}_{k} - {x}_{k}^{t} )}^{2} \text{?}$$

$$\text{?} \text{indicates text missing or illegible when filed}$$

signifies the deviation from the data for a given data point. In this context, the Hamiltonian operator defines the total energy of the system, as per the principles of quantum mechanics, and the ground state of this operator, denoted as |Ψ⁻t, minimizes the error.

The generator module plays an integral role in the generation of the operator. This module essentially constructs the necessary quantum operators that are required to define a given observable within the Hilbert space.

### Step 2: Modeling a Correlation to Deduce Probability of the Event 54

Once the operator is established, we model the correlation between variables, leveraging the principles of quantum mechanics. This process involves finding the wave-packet state |Ψ⁻ that coheres to the observation, which gives us the ability to ascertain the probability of an outcome. Given observations xk for a set of operators A k, the probability of outcome j for any operator B=Vdiag(b)V^{†} is given by pⱼ=|V^{†}Ψ|ⱼ².

Here, the QOG plays a significant role in modeling the correlation between represented variables. The QOG's output quantum operators are manipulated to deduce the correlations between the quantum variables represented by the quantum states.

In a preferred embodiment, as illustrated in FIG. 5, an exemplary system diagram of the Quantum Cognition Modeling Framework, also known as QOG Framework, or simply QOG, is designed to implement quantum cognition for event prediction. This system comprises a processor and a non-transitory storage element coupled to the processor. The storage element contains encoded instructions, which when executed by the processor, enable a sequence of operations facilitating event forecasting based on represented observables.

In another embodiment, the encoded instructions direct the processor to transform an observable in Hilbert Space into an operator. This process occurs through a specialized generating module in the system. The generating or generator module uses a Variational Quantum Eigensolver (VQE) to determine the minimum eigenvalue of a fixed error Hamiltonian. Once this value is computed, the parameters from the ansatz are employed to deliver a ground state, which aids in generating operators for event prediction.

Yet in another embodiment, the generating module incorporates an additional component to adjust weights in the error Hamiltonian. The adjustment is carried out via a gradient descent operation, utilizing the learned fixed ground state. This component refines the error Hamiltonian, thereby enhancing the system's forecasting accuracy.

In a further embodiment, the generating module is designed to prevent overfitting. This is achieved by controlling the extent of learning derived from any given step. This mechanism ensures that the model doesn't become excessively fitted to the training data, thereby maintaining the reliability of its predictions.

In a preferred embodiment, the generating module aggregates all data at a particular data point or moment in time to create the operator. This allows the error Hamiltonian to represent the comprehensive deviation of the observable operators from their observations. This feature provides a holistic view of the data at a particular instant, thereby increasing the scope and accuracy of the predictions.

In another embodiment, the QOG system includes a module specifically configured to calculate the probability of an outcome for an operator. This probability is computed by the squared norm of the projection of the state vector onto the eigenstate of the error Hamiltonian, providing a quantifiable metric for the likelihood of a particular outcome.

Yet in another embodiment, the system contains a module for calculating the expected value of any real-valued observable. This is achieved by computing the expected value of the corresponding operator in the ground state. This capability enables the system to anticipate the probable value of the observables.

In a further embodiment, the QOG system features a training module. This module learns all operators, up to an arbitrary rotation, using stochastic gradient descent implemented on a classical computer. The gradient descent operation on a quantum computer is formulated as a ground state problem, aligning the learning process with the quantum nature of the operators. In a preferred embodiment, the system is designed to infer the probability of an event by modeling a correlation between represented variables. It uses the encoded operator and the learned ground state, giving the system the ability to understand and predict correlations between different variables. In yet another embodiment, the generating module leverages a specific training paradigm involving Hilbert Space Expansion, Hilbert Space Pruning, and Hierarchical Learning. These techniques allow the system to manage exceptions, optimize learning, and train groups of operators both separately and together, enabling effective event forecasting based on quantum cognition principles. These steps underpin a novel quantum machine learning paradigm, where correlations in high-dimensional Hilbert spaces can capture complex relationships in the data. The modeling and inference involve quantum principles, providing an avenue for a logarithmic economy of representation and holistic inference, potentially yielding applications in finance, large language models, robotics, healthcare, and more.

The present disclosure also may pertain to a quantum system designed to encode data within its ground state through controlled manipulation of physical controls, facilitated by an artificial neural network (ANN), in coordination with a quantum subsystem operating at low temperatures. Notably, the primary advantage of this approach is its exemption from the necessity to compute or model the Error Hamiltonian, distinguishing it from conventional gate-based operations

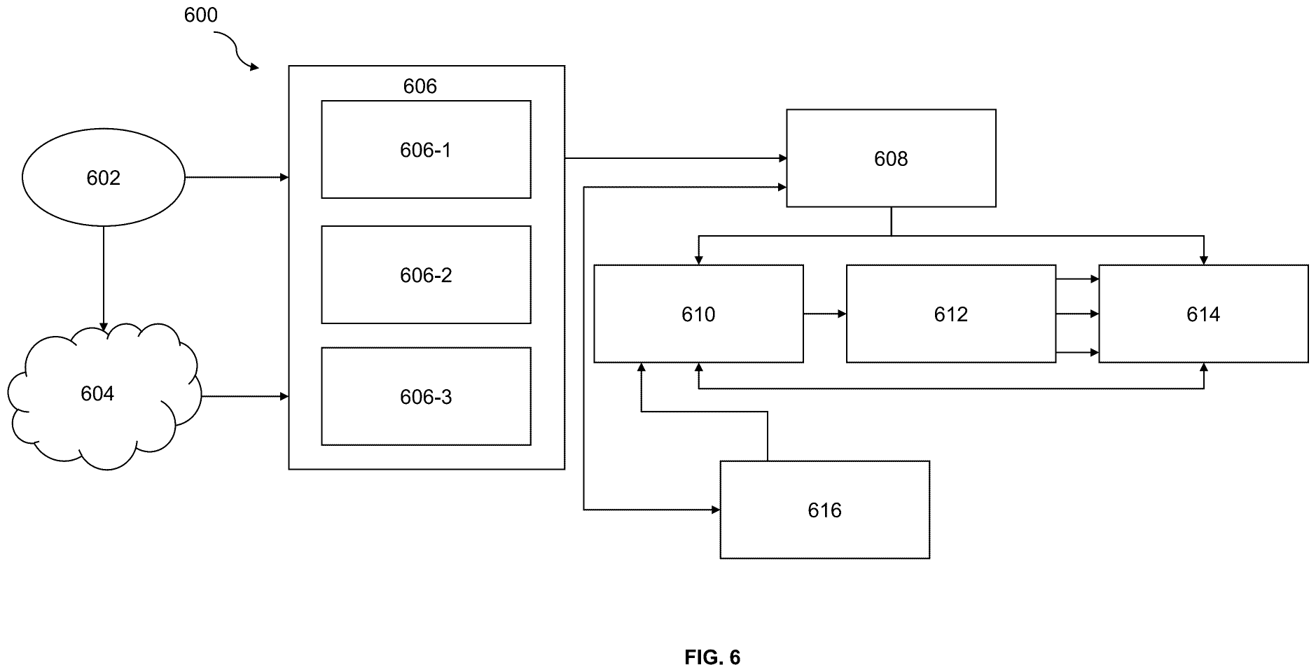

FIG. 6 illustrates a system 600 for training and forecasting with a quantum subsystem using an artificial neural network (ANN) in accordance with an exemplary embodiment of the present invention. The system 600 includes a datapoint source 602, a communication network 604, an interface 606, a processor 608, the ANN 610, a digital to analog converter 612, a quantum subsystem 614, and a memory device 616. The datapoint source 602 generates at least one data point. The datapoint source 602 includes, but is not limited to a user, a sensor network, or a networked system, or an intelligent agent. The datapoint source 602 may be directly connected to the interface 606 or coupled to the interface 606 using the communication network 604.

The communication network 604 supports at least one of a wired or a wireless communication protocols. The communication network 604 is responsible for enabling communication between the datapoint source 602 and the interface 606. The at least one wired communication protocol may include, but is not limited to an Ethernet (IEEE 802.3), local area network (LAN) connection, a point-to-point connection, or a Universal Serial Bus (USB) protocol. The at least one wireless communication protocol may include but is not limited to radio frequency (RF), infrared (IrDA), Bluetooth, wireless LAN connection, Zigbee (and other variants of the IEEE 802.15 protocol), a wireless fidelity Wi-Fi or IEEE 802.11 (any variation), IEEE 802.16 (WiMAX or any other variation), direct sequence spread spectrum (DSSS), frequency hopping spread spectrum (FHSS), global system for mobile communication (GSM), general packet radio service (GPRS), enhanced data rates for GSM Evolution (EDGE), long term evolution (LTE), cellular protocols (2G, 2.5G, 2.75G, 3G, 4G or 5G), near field communication (NFC), satellite data communication protocols, or any other protocols for wireless communication. The communication network 604 may include software, hardware, or computer applications to facilitate the exchange of signals or data in any format known in the art, related art, or developed in the future. The communication network 604 may be chip level communication circuitry, a circuit implementing semiconductor topology for communication, or any other communication protocols defined for processor, memory access, or exchange of signals or data in any format known in the art, related art, or developed in the future. The communication network 604 may be chip level communication circuitry, a circuit implementing semiconductor topology for communication, or any other communication protocols defined for processor or memory access.

Further, a standard bus architecture may be employed in the system 600, a novel approach to handling high-dimensionality problems and complex interdependencies in data modeling common in the field of the ANN and machine learning. The bus serves as an illustrative structure, mapping the intricate connectivity of the system 600 components. The system 600 components are collectively responsible for addressing the combinatorial explosion issue. Each of the components is interlinked via the bus, enabling the sharing of data, instructions, and resources vital for the system 600 performance.

The datapoint source 602, another critical component attached to the bus, is utilized to receive datapoint(s) or observable(s), effectively initializing the system 600. Conversely, an output module (not shown), also connected to the bus, displays the results of the system 600 operations in an easy-to-understand, human-like interaction format. The data flow from receiving or obtaining datapoint(s), processing and then to output is facilitated via the bus. The bus interconnectivity is required for exchanging data among the components.

The bus, in essence, is not just a structure but a fundamental map that demonstrates the operational flow of the system 600. By highlighting the interconnectedness and cooperation of the system 600 components, the bus is instrumental in visualizing how the system 600 addresses the communication requirements of the system 600 to optimize the performance of ANN/ML models.

The interface 606 is a human-machine interface enabling the system 600 to collect the datapoints. For example, in a healthcare context a patient's data points, including age, blood pressure, cholesterol level, scans, pixel value of scans, or any other related parameter of patients can be provided through a touch screen. The interface 606 may be a liquid crystal display (LCD), a light-emitting diode (LED) screen, an organic light-emitting diode (OLED) screen, or another display device to receive the data point from the datapoint source 602. Alternatively, the interface 606 may be buttons, voice commands, haptic feedback, or other interfaces.

The interface 606 includes but is not limited to user devices 606-1, a sensor network 606-2, or a networked system 606-3. The user devices 606-1 may include, but are not limited to mobile devices, tablet, or desktop or laptop computer. The sensor network 606-2 may include, a temperature sensor, a proximity sensor, a pressure sensor, an infrared sensor, a motion sensor, an accelerometer sensor, a gyroscope sensor, a smoke sensor, a chemical sensor, a gas sensor, an optical sensor, a light sensor, air quality sensor, audio sensor, contact sensor, carbon monoxide detection sensor, camera, biomedical sensor, level sensor, ultrasonic sensor, a biometric sensor, air quality sensor, electric current sensor, flow sensor, humidity sensor, fire detection sensor, a pulse sensor, a blood pressure sensor, an electrocardiogram (ECG) sensor, a blood oxygen sensor, a skin electrical sensor, an electromyographic sensor, an electroencephalogram (EEG) sensor, a fatigue sensor, a voice detector, an optical sensor or a combination thereof to receive input at the interface 606. The networked system 606-3 may include a third-party device for generating a data point and transmitting the generated data point to the interface 606 using the communication network 604. For example, in a healthcare context, a patient's data points, like blood pressure can be monitored in real time using a wearable device or and transferred through a sensor network 606-2.

The processor 608 is communicatively coupled to the ANN 610, the digital-to-analog converter 612, the quantum subsystem 614, and the memory device 616. The processor 608 receives and stores the data points (as explained below in detail). The processor 608 is capable of executing software instructions or algorithms to implement functional aspects of the present invention. The processor 608 can be any commercially available on-site computer or a cloud system. The processor 608 can also be implemented as a Digital Signal Processor (DSP), a controller, a microcontroller, a designated System on Chip (SoC), an integrated circuit implemented with a Field Programmable Gate Array (FPGA), an Application Specific Integrated Circuit (ASIC), or a combination thereof. The processor 608 can be implemented using a co-processor for complex computational tasks. The processor 608 performs all the functions required for fulfilling the operational requirements of the system 600 including and storing the dataset into the memory device 616.

The operational requirements of the system 600 include performing a series of complex operations to encode the observables or datapoints for eventually generating an operator to correspond to the observables in the Hilbert Space. The operations involve observing the datapoint, encoding the datapoint into the operator, and representing observables in Hilbert Space.

The memory device 616 may include any of the volatile memory elements (for example, random access memory, such as DRAM, SRAM, SDRAM, etc.), non-volatile memory elements (for example, ROM, hard drive, etc.), storage media, any other memory supporting the quantum computing or combinations thereof. The memory device 616 may have a distributed architecture, where various components are situated remotely from one another but can be accessed using the processor 608. The memory device 616 may include one or more software programs, each of which includes an ordered listing of executable or encoded instructions for implementing logical functions and functionality of the present invention (explained in detail in FIG. 2). The memory device 616 further includes one or more registers to store the at least one data point of the data set for feeding data serially into the ANN 610. The memory device 616, one of the vital nodes connected to the bus (discussed above), is crucial for the storage and retrieval of data and encoded instructions.

The ANN 610 receives the dataset from the processor 608. The ANN 610 maps the dataset to one or more physical controls based on the stored parameters. The mapping of the dataset to one or more physical controls includes generating electrode voltage, capacitances of capacitors connecting Cooper boxes, electrode current, or any output required to control the quantum subsystem 614. The quantum subsystem 614 can be any other quantum hardware component developed during the technological progression of the quantum computing and is capable of performing the functionality of the quantum subsystem 614 of the present invention. Examples of candidate quantum subsystems are at least one of quantum dots, trapped ions, optical lattice, cooper boxes, etc.

Alternatively, the ANN 610 may receive at least one datapoint at a time from the processor 608. The ANN 610 maps the datapoints to one or more physical controls using the ANN 610 based on the one or more stored parameters. The ANN 610 may generate a series of physical controls as outputs from observables or datapoints as input data points using a parametrized mapping method. The observables or datapoints may be represented as operators on Hilbert space.

The digital-to-analog converter 612 translates digital output of the ANN 610 to a physical value of the one or more physical controls. In general, quantum computing processors measure physical value. Whereas the system 600 of the present invention translates the digital values to the analog physical control signals to the quantum subsystem 614. Therefore, digital values received as datapoints and processed by ANN are inputted to the digital-to-analog converter 612 for generating output analog signals in the form of current, voltage, or any physical variable supported by the quantum subsystem 614.

The system 600 of the present invention implements ANN 610 to interact with quantum hardware based on the digital input received through a classical system. Hence, ANN 610 helps to transform the digital inputs into the physical controls for the quantum subsystem 614 by overcoming the limitations of Turing machines.

The quantum subsystem 614 is annealed at low temperatures based on the physical controls. Quantum annealing is a computational method used to locate low-energy states of a system 600, typically focusing on the ground state. Like classical annealing, it leverages the principle that natural systems tend towards lower energy states due to increased stability. However, quantum annealing utilizes quantum effects, such as quantum tunneling, to achieve a global energy minimum more accurately and quickly than classical annealing. In quantum annealing, thermal effects and other forms of noise may be present to facilitate the annealing process. Nevertheless, the final low-energy state attained may not always be the global energy minimum. Adiabatic quantum computation can be viewed as a specialized form of quantum annealing, where the system 600 ideally begins and remains in the ground state throughout an adiabatic evolution. Consequently, quantum annealing systems and methods find general implementation in quantum computing-based systems.

The processor 608, the interface 606, the ANN 610, the digital-to-analog converter 612, the quantum subsystem 614, and the memory device 616 may be integrated into a one module or may be independent units.

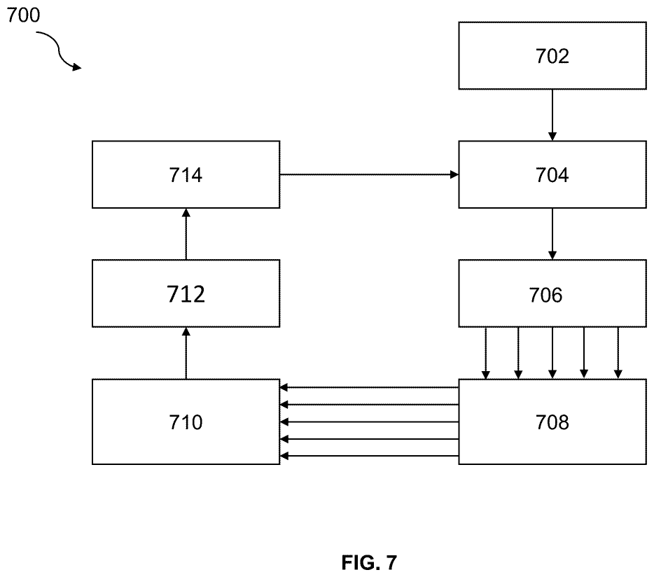

FIG. 7 illustrates a functional diagram 700 of training with a quantum subsystem using an artificial neural network (ANN) in accordance with an exemplary embodiment of the present invention. The diagram 700 presents a training mechanism employing a quantum subsystem and the ANN, as described in an exemplary embodiment of this invention. The process commences with the collection of a dataset, referenced by element 702. The dataset is further incrementally fed into the ANN, indicated by element 704. In one example, a set of registers are implemented to feed one data point at a time into the ANN. The network undertakes the role of mapping the dataset to a series of physical controls, signified by element 706, that interact with the quantum subsystem. The physical controls influence the behavior of qubits and the interaction between them, guiding a system towards the desired low energy state. One such physical control may be an analog voltage applied on the quantum subsystem. Other controls may include temperature, coupling strength, flux tuning, or any other physical control supported by the quantum subsystem.

As the physical controls are applied, the quantum subsystem, shown as element 708, is precisely configured to operate at low temperatures. The impact of these controls is quantified by measuring the generalized forces, marked as element 710, exerted upon the quantum subsystem.

The ANN fine-tunes the physical controls through a process encapsulated by element 712. This fine-tuning is directed towards lowering the quantum subsystem's energy levels while concurrently stabilizing the curvature of the energy in relation to the dataset. The process is an iterative process that utilizes one datapoint at a time to lower the energy state and iterates through each datapoint several times until the system achieves lower energy state of the inputted data set.

Concluding this process, the refined parameters of the ANN are preserved, as denoted by element 714. The parameters form a trained dataset, which is subsequently utilized as input for the quantum subsystem to carry out predictive tasks. This delineates a synergistic loop where the quantum subsystem and the ANN are iteratively aligned to augment learning efficacy and predictive precision.

Quantum annealing, a method utilized in quantum computing to tackle optimization problems, exploits quantum mechanic principles. The quantum annealing process gradually adjusts the state of a quantum subsystem, typically comprising qubits, until it converges to a low-energy configuration representing the optimal solution. Physical controls, such as voltage, are instrumental in steering the quantum subsystem during the annealing process. In quantum annealing setups employing superconducting qubits, which are microscopic circuits crafted from superconducting materials, voltage manipulation becomes particularly crucial. One common approach involves flux tuning, where voltage variations modulate the magnetic flux threading the superconducting qubits. This, in turn, alters the qubits' energy levels and influences their interactions. Precise voltage adjustments on control lines within the quantum processor enable fine-tuning of qubit-qubit interactions and overall system behavior. Furthermore, voltage control can regulate coupling strength between qubits. By manipulating specific control elements like tunable capacitors or Josephson junctions, we can modulate the strength of interactions among adjacent qubits. This flexibility in coupling strength customization is pivotal for tailoring quantum annealing to diverse optimization problems. Temperature regulation is another essential aspect of optimizing quantum annealing performance. By finely adjusting the temperature of superconducting components, researchers can shape the energy landscape of the quantum subsystem, enhancing its ability to explore solution spaces effectively. In the present invention, the system takes one data point at a time to anneal the system and iterate through data points, potentially more than once, to lower the energy over the data set. In other words, the system implements gradient descent to lower the energy states of the quantum subsystem.

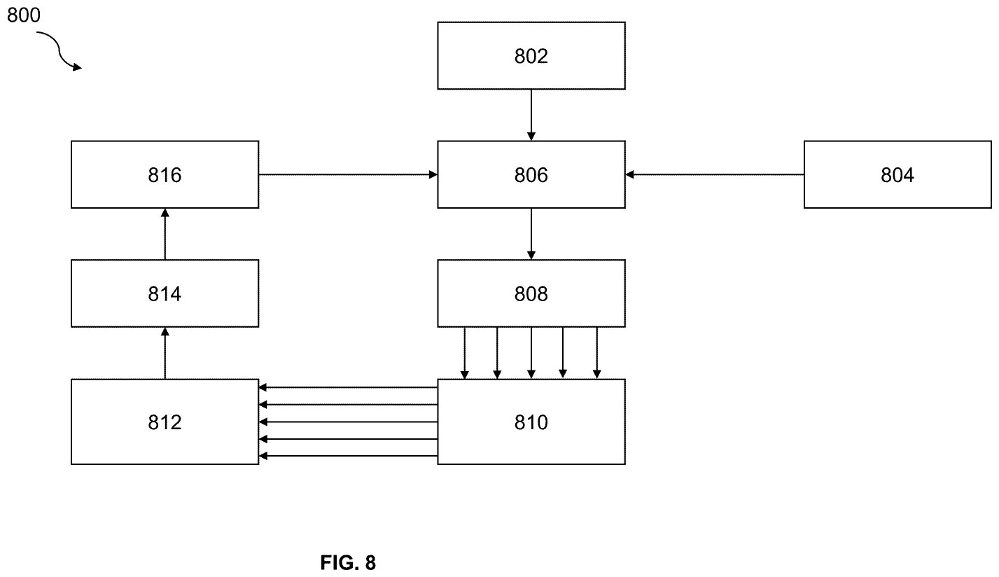

FIG. 8 illustrates a functional diagram 800 of forecasting with a quantum subsystem using an artificial neural network (ANN) in accordance with an exemplary embodiment of the present invention. The system begins with a datapoint fed into the ANN, denoted by element 802. This network utilizes stored parameters, referenced by element 804, to map the data point(s) to one or more physical controls, as indicated by element 806.

The physical controls then configure the quantum subsystem, referenced by element 808, which is maintained at low temperatures to facilitate the processing. The quantum subsystem is influenced by the physical controls to exert generalized forces, shown by element 810.

The system proceeds to measure these forces (depicted by element 812), followed by an iterative process of gradient descent for adjusting the forecast value. The ANN utilizes the gradient descent based on the input datapoint(s) and stored parameters to modify the physical controls, as depicted by component 814. This adjustment aims to lower the quantum subsystem's energy with respect to a training dataset while keeping the energy curvature constant concerning the data point(s).

Finally, the system forecasts a missing data value within the dataset, which is carried out by element 816. The entire process iterates in a controlled feedback loop, ensuring the system is finely tuned for optimal forecasting outcomes by lowering the energy of the quantum subsystem, enhancing the predictive accuracy of the system.

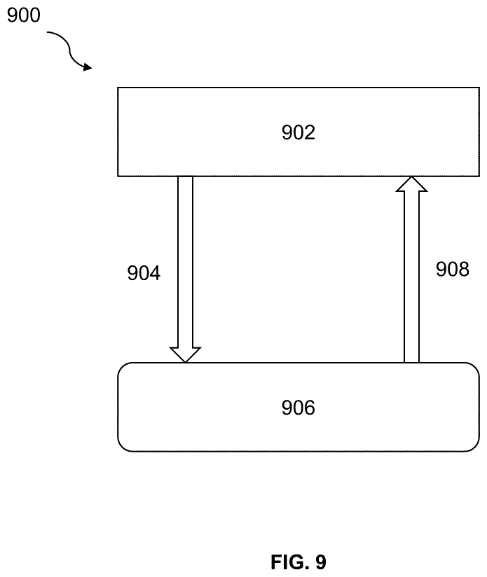

FIG. 9 illustrates an interaction 900 of a quasi-classical system 902 with a quantum subsystem 906 in accordance with an exemplary embodiment of the present invention. While a determination or mathematical modeling of the Hamiltonian operator is not necessary, manipulation of the operator may be achieved through the physical controls of the system envisaged above. This ground state inferred aims to lower the aggregated deviation of observable operators from observations of a given data point. The ground state can be a finding a state with a smaller vector that can represent an entire image or dataset. Although the data may not be precisely represented, the system may ask questions about the state of representation and the accuracy of the representation. In traditional quantum computing, information is often lost when a second variable is observed. However, this methodology ensures the preservation of previous information, even as new variables are observed.

More precisely, the requirements for a physical quantum subsystem 906 are to encode data in its ground state and suggest a potential concrete implementation in a quantum hardware for satisfying the requirements.

The two-part system, consisting of a quantum subsystem 906 at low temperature and therefore in or near the ground state, is controlled adiabatically by the quasiclassical system 902 through generalized coordinates dᵢ({xₖ}, θ), which are functions of the data xx parametrized by the vector of parameters θ. The quantum subsystem's 906 Hamiltonian is given by:

Ĥ({xₖ})=Ĥ(dᵢ({xₖ},θ))

The derivatives of the energy of the quantum subsystem 906 with respect to generalized coordinates represent generalized forces and are measured directly by the controlling devices of the quasiclassical system 902:

$${F}_{i} = - \frac{\partial E}{\partial {d}_{i}} = - ψ * \frac{\partial \hat{H}}{\partial {d}_{i}} ψ$$

The curvature of energy is fixed with respect to each data point according to:

$${c}_{k} = \frac{{\partial }^{2} E}{\partial {x}_{k}^{2}} = - \frac{\partial }{\partial {x}_{k}} {\sum }_{i} ( \frac{\partial {d}_{i}}{\partial {x}_{k}} {F}_{i} ) = \frac{1}{{σ}_{i}^{2}}$$

The gradient of the curvatures with respect to parameters θ is given by:

$${f}_{k} = \frac{\partial {c}_{k}}{\partial θ} = - \frac{{\partial }^{2}}{\partial {x}_{k}^{2}} {\sum }_{i} {F}_{i} \frac{\partial {d}_{i}}{\partial θ}$$

Parameters θ are learned through curvature preserving gradient descent:

$$g = \frac{\partial E}{\partial {θ}_{n}} = {\sum }_{i} \frac{\partial E}{\partial {d}_{i}} \frac{\partial {d}_{i}}{\partial θ} = - {\sum }_{i} {F}_{i} \frac{\partial {d}_{i}}{\partial θ}$$

$$θ \to θ - γ ( I - {\sum }_{k} {f}_{k} {f}_{k}^{T} ) g$$

Where γ is the learning rate. It is remarkable that to the extent that the quantum subsystem is maintained in the ground state, no measurements of the state are required, in contrast with universal gate quantum computers. The learning and forecasting are achieved through measurement of generalized forces. Forecasting an observable x₁ given the other observables is similarly achieved through measurement of generalized forces only, by varying x₁ until the minimum energy is achieved, i.e.:

$$\frac{\partial E}{\partial {x}_{i}} = - {\sum }_{i} {F}_{i} \frac{\partial {d}_{i}}{\partial {x}_{i}} = 0$$

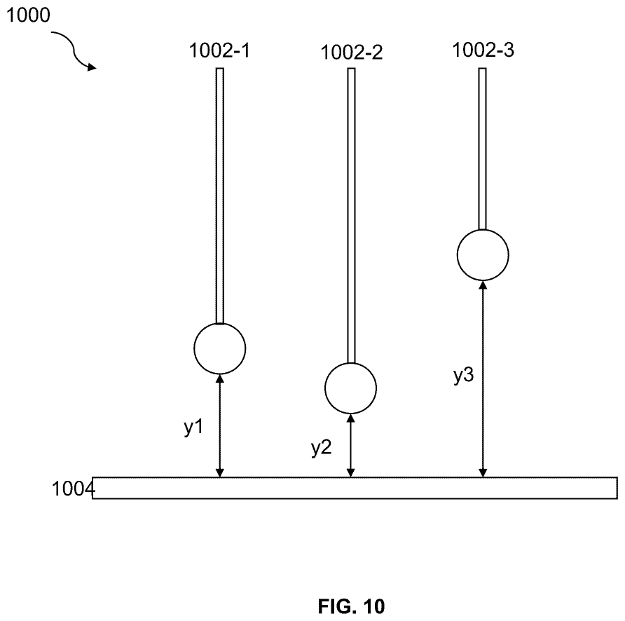

FIG. 10 illustrates a diagram 1000 of a quasi-classical layer of a quantum subsystem at low temperature in accordance with an exemplary embodiment of the present invention. The diagram 1000 includes one or more quasi-classical layers (1002-1, 1002-2, 1002-3) and a ground state 1004 of the quantum subsystem. The one or more quasi-classical layers (1002-1, 1002-2, 1002-3) of the quantum subsystem are annealed to low temperature using gradient descent.

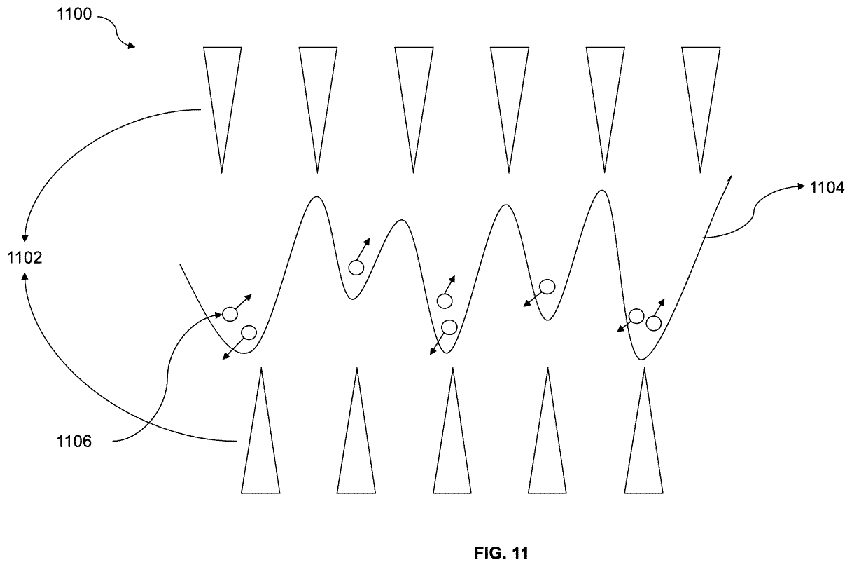

FIG. 11 illustrates a diagram 1100 of electron spin of datapoints in accordance with an exemplary embodiment of the present invention. The diagram 1100 includes electrodes 1102, wave or signal 1104, and electron spin 1106. A voltage is applied to the electrodes 1102 to excite the electrons. The excitation voltage causes the electron spin 1106. The electron spin 1106 may have distinguishable states such as “up spin” and “down spin.

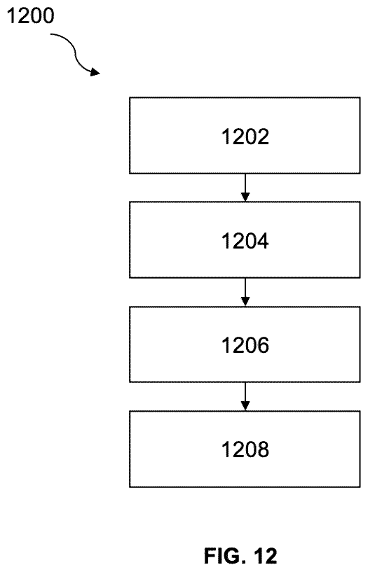

FIG. 12 illustrates a method (1200) for forecasting an observable with a quantum subsystem in accordance with an exemplary embodiment of the present invention. The method (1200) comprises the following steps: (a) generating (1202) a series of physical controls, through an artificial network (ANN) within a classical subsystem, configured for interaction with a quantum sub-system; (b) measuring (1204) the generalized forces exerted by the controls on the quantum sub-system; (c) adjusting (1206) the controls, through the ANN, in order to lower energy of the quantum sub-system with respect to a training data set, while maintaining a constant curvature of the energy with respect to an input data set; and (d) forecasting (1208) a value of a missing data in the data set by computing a value of the missing data that lowers the energy of the quantum sub-system.

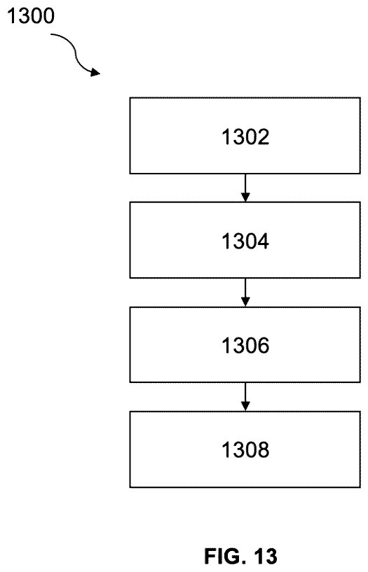

FIG. 13 illustrates a method (1300) for forecasting an observable using a quantum subsystem comprising a quantum a dot-based quantum layer in accordance with an exemplary embodiment of the present invention. The method (1300) comprises the following steps: (a) generating (1302) a series of physical controls, controlled by a series of electrode voltage, through an artificial neural network within a classical subsystem, configured for interaction with a quantum sub-system comprising a plurality of quantum dots in a two-dimensional substrate; (b) measuring (1304) the generalized forces exerted by the controls on the quantum sub-system, wherein the generalized forces are measured as induced charges on each quantum dot; (c) adjusting (1306) the controls, through the ANN, in order to lower energy of the quantum sub-system with respect to a training data set, while maintaining a constant curvature of the energy with respect to an input data set; and (d) forecasting (1308) a value of a missing data in the data set by computing a value of the missing data that lowers the energy of the quantum sub-system.

In one example, a system is implemented is arranging quantum dots in an array on the surface of a GaAs/AlGaAs heterostructure controlled electrostatically using electrodes. Here, the generalized forces are measured as electric capacitance with respect to each electrode. The Hilbert space is of the size 2^{2m}, where m is the number of quantum dots. The resulting Hamiltonian is sufficiently expressive to allow learning:

$$\hat{H} ( \{ {d}_{i} \} ) = - {\sum }_{α} {ϵ}_{α} ( \{ {d}_{i} \} ) {\hat{n}}_{α} - {\sum }_{( αβ ) , σ} {t}_{αβ} ( \{ {d}_{i} \} ) ( {\hat{c}}_{ασ}^{†} {\hat{c}}_{βσ} + h . c . ) - {\sum }_{α} \frac{{U}_{α} ( \{ {d}_{i} \} )}{2} {\hat{n}}_{α} ( {\hat{n}}_{α} - 1 ) - {\sum }_{αβ} {V}_{αβ} ( \{ {d}_{i} \} ) {\hat{n}}_{α} {\hat{n}}_{β} + …$$

Here the ellipse ( . . . ) stands for higher order terms. In this implementation of the present invention, a more strongly coupled system is preferred instead of knowing or replicating any specific Hamiltonian and qubits in standard quantum computing systems. Hence, the quantum dots closer to each other in a 2D pattern allow for higher order tunneling and interactions.

Hilbert space data encoding: In one example, a joint probability distribution of K observables, each spanning a set of M possible values. For example, 100 binary observables would correspond to K=100 and M=2. The joint probability distribution of these outcomes has O(M^{K}) entries, i.e., grows exponentially with the number of observables. Instead, a Hilbert state model with dimensionality N≥M is used, where each observable corresponds to a Hermitian operator on this Hilbert space Aₖ, 1≤k≤K. The complexity of this representation is O(KN²). Thus, an HSM formulation allows to grow the number of variables defining the joint probability distribution only linearly in the number of observables. The present invention is particularly interested in the scenario of K>>N.

Observables as operators: Each observable Ax is represented by a Hermitian operator and its spectral decomposition:

Aₖ=UₖSₖUₖ^{†}

Where U is unitary and Sₖ is the diagonal matrix of real valued eigenvalues {aₖⁱ}, 1≤i≤N, which represent potential values of the observable corresponding to the operator A∧. The state is given by a complex valued vector in Hilbert space (wave function), Ψᵢ, such that the probability of measurement k being sₖⁱ is given by |U^{†}Ψ|². The price users pay for this parsimonious representation is that, generally speaking, as is the case in quantum mechanics, measurements become mutually incompatible, meaning that a sharp measurement of operator A and a sharp measurement of operator B are not possible at the same time, unless those operators commute [A, B]=0. According to the quantum cognition theory, this is precisely the source of ubiquitous logical fallacies. In quantum mechanics, the fact that a pair of non-commutative operators cannot be measured sharply simultaneously leads to Heisenberg Uncertainty Principle. Thus, as the operator of position x and operator of momentum p are mutually non-commutative [x], p]≠0, the uncertainties of simultaneous measurements of position Δx and momentum Δp obey the inequality:

$$\vert Δ x \vert \vert Δ p \vert \geq \frac{ℏ}{2}$$

Given a non-sharp measurement of x˜x0 and p˜p0, the lower bound of h/2 is achieved in the so-called wave-packet state, which corresponds to Gaussian distributions for both the position:

$$ψ ( x ) = \frac{1}{{π}^{\frac{1}{4}} {σ}^{\frac{1}{2}}} exp ( - \frac{{( x - {x}_{0} )}^{2}}{2 {σ}^{2}} + \frac{{ip}_{0} x}{ℏ} )$$

And momentum:

$$ϕ ( p ) = \frac{{σ}^{\frac{1}{2}}}{{π}^{\frac{1}{4}}} exp ( - {σ}^{2} \frac{{( p - {p}_{0} )}^{2}}{2} - \frac{{ix}_{0} p}{ℏ} )$$

Generalized wave-packet state Now, in another example, a data point {xₖ} corresponds to measurements of operators Aₖ. There is no state Ψ that corresponds to a sharp measurement, giving rise to {xₖ}. Instead, the present invention introduces the generalized wavepacket (GWP) state Ψ₀ that corresponds to the ground state of the following “error” Hamiltonian:

$$\hat{H} ( \{ {x}_{k} \} ) = {\sum }_{k}^{K} \frac{1}{2 {σ}_{k}^{2}} {( {x}_{k} \hat{I} - {\hat{A}}_{k} )}^{2}$$

Where I is the identity operator. Here σₖ² corresponds to some measure of error tolerance with regard to each observable. This error Hamiltonian generates an error of a fuzzy measurement for a given state y and a given data point:

$$E ( \{ {x}_{k} \} , ψ ) = {ψ}^{*} \hat{H} ( \{ {x}_{k} \} ) ψ$$

As Wo minimizes this error, this represents the closest approximation to a given data point {yₖ}. In a sufficiently large Hilbert space, namely of size M^{K}, direct product of Hilbert spaces corresponding to all possible outcomes for each operator is embedded, all operators are made mutually commutative, to make all the measurements sharp. However, this leads to the problem of the curse of dimensionality and exponential growth of the representational space. As the dimensionality of the Hilbert space is reduced, representation becomes more parsimonious, and the fidelity of the representation is being sacrificed. Thus, data encoding in a wave-packet state represents a form of lossy compression. In this case, the particular form of the error Hamiltonian is not important. Any reasonable non-negative error function may be used, with only minor and obvious modifications to what follows. In particular, for binary variables xx, the cross-entropy form of error Hamiltonian can be implemented:

$$\hat{H} ( \{ {x}_{k} \} ) = {\sum }_{k}^{K} - {x}_{k} ln ( {\hat{P}}_{k} ) - ( 1 - {x}_{k} ) ln ( \hat{I} - {\hat{P}}_{k} )$$

Where the eigenvalues of Pₖ are constrained to be between 0 and 1.

Training: Given a set of training data points, {yₖ}ₜ, 1≤t≤T, the objective of training is to learn the operators Aₖ that minimize the aggregate error:

$${\hat{A}}_{k}^{0} = {arg min}_{{\hat{A}}_{k}} {\sum }_{t = 1}^{T} {E}_{t}$$

Training consists of alternating gradient descent steps with respect to U, and recalculating the ground state for each data point. If the measurement values are not fixed, gradient descent with respect to eigenvalues {sₖⁱ} is also included. Gradient descent may be done according to the stochastic gradient descent method using mini-batches of data points.

Gradient decent with respect to U: Starting with the previous estimate of Uₖ⁰ and given the set of coherent states Ψₜ for each data point t, the present invention looks to find an improved set of eigenvectors.

$${U}_{k} = {U}_{k}^{0} exp ( - {iX}_{k} )$$

Where Xₖ is a Hermitian operator representing incremental optimization step. The error Eₖ corresponding to the observation xₜ^{k} of k-th operator with is given by:

$${E}_{k} = {\sum }_{t} {ψ}_{t}^{*} {U}_{k}^{0} exp ( - {iX}_{k} ) {D}_{t}^{k} exp ( {iX}_{k} ) {U}_{k}^{0 †} {ψ}_{t}$$

Where Dₜ^{k} is a diagonal matrix with

$${( {D}_{t}^{k} )}^{j} = \frac{1}{2 {σ}_{k}^{2}} {( {x}_{t}^{k} - {a}_{k}^{j} )}^{2}$$

For small X, can be rewritten as:

$${E}_{k} \approx {E}_{k}^{0} + i {\sum }_{t} {ψ}_{t}^{*} {U}_{k}^{0} [ {D}_{t}^{k} , {X}_{k} ] {U}_{k}^{0 †} {ψ}_{t}$$

Taking the derivative with respect to matrix element Xₖ^{js}, the present invention obtains:

$$\frac{\partial {E}_{k}}{\partial {X}_{k}^{js}} = i {\sum }_{t} {( {ϕ}_{t}^{k} )}_{j}^{*} ( {( {D}_{t}^{k} )}^{j} - {( {D}_{t}^{k} )}^{s} ) {( {ϕ}_{t}^{k} )}_{s}$$

Where ϕₜ^{k}=Uₖ⁰Ψₜ.

Gradient with respect to eigenvalues. Similarly, if the present invention is dealing with discretized continuous observables, the set of discrete eigenvalues aₖ^{j} for each operator Aₖ is optimized. The gradient is then given by:

$$\frac{\partial {E}_{k}}{\partial {a}_{k}^{j}} = {\sum }_{t} {ψ}_{t}^{*} {U}_{k} diag ( \frac{{a}_{k}^{j} - {x}_{t}^{k}}{{σ}_{k}^{2}} ) {U}_{k}^{†} {ψ}_{t}$$

Forecasting given an arbitrary set of inputs {xₖ} corresponding to a set of operators {Aₖ}, the present invention forecasts the probabilities of all possible measurements {bⱼ} of some arbitrary operator B=Vdiag(b)V^{†} according to the rules of quantum probabilities:

Where Wo is the coherent state corresponding to inputs {yₖ}. The expected value of a given observable is then given by:

[symbol]

(B)=Ψ₀*\hat{B}Ψ₀

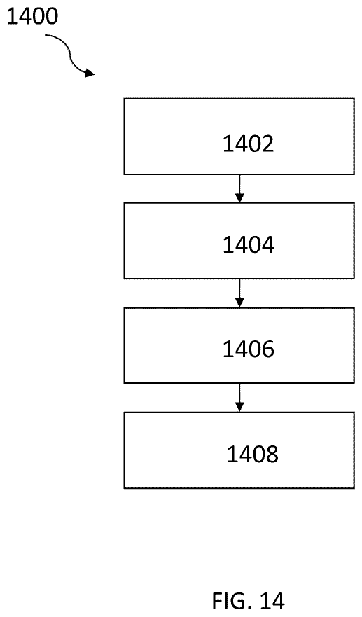

FIG. 14 illustrates a method (1400) for forecasting an observable using a quantum subsystem comprising trapped ions in accordance with an exemplary embodiment of the present invention. The method (1400) comprises the following steps: (a) generating (1402) a series of physical controls, controlled by a series of electrode voltage, through an artificial neural network within a classical subsystem, configured for interaction with a quantum sub-system comprising of a three-dimensional array of coupled resonant cavities that trap ions in resonant electromagnetic fields created by tunable lasers, with a constant electric field in each cavity tuning the resonant frequency of the ions; (b) measuring (1404) the generalized forces exerted by the controls on the quantum sub-system, wherein the generalized forces are measured as induced charges on controlling electrodes and/or through measuring scattering of laser emission which are reflective of the ions' interactions with the electromagnetic fields within the cavities; (c) adjusting (1406) the controls, through the ANN, in order to lower energy of the quantum sub-system with respect to a training data set, while maintaining a constant curvature of the energy with respect to an input data set; and (d) forecasting (1408) a value of a missing data in the data set by computing a value of the missing data that lowers the energy of the quantum sub-system.

Another possibility for implementation is through coupled cavities with trapped ions and resonant frequencies. The resulting Jaynes-Cummings-Hubbard is (h=1):

$$\hat{H} ( \{ {d}_{i} \} ) = {\sum }_{j} {ω}_{j} ( \{ {d}_{i} \} ) {\hat{a}}_{j}^{†} {\hat{a}}_{j} + {\sum }_{j} {Ω}_{j} ( \{ {d}_{i} \} ) {\hat{σ}}_{j}^{+} {\hat{σ}}_{j}^{-} + {\sum }_{jk} {γ}_{jk} ( \{ {d}_{i} \} ) ( {\hat{a}}_{j}^{†} {\hat{a}}_{k} + {\hat{a}}_{k}^{†} {\hat{a}}_{j} ) + {\sum }_{j} {η}_{j} ( \{ {d}_{i} \} ) ( {\hat{a}}_{j} {\hat{σ}}_{j}^{+} + {\hat{a}}_{j}^{†} {\hat{σ}}_{j}^{-} )$$

Where ∧aⱼ are photon annihilation operators, ∧σⱼ^{±} are Pauli operators for the two level system (trapped ion), ωⱼ is the tunable resonant frequency of the cavity, Ωⱼ is the tunable resonant frequency of the trapped ion, ηⱼ is the tunable Rabi frequency characterizing the coupling between photons and ions, and the coupling between cavities occurs through photon tunneling between cavities with a tunable coefficient γⱼₖ.

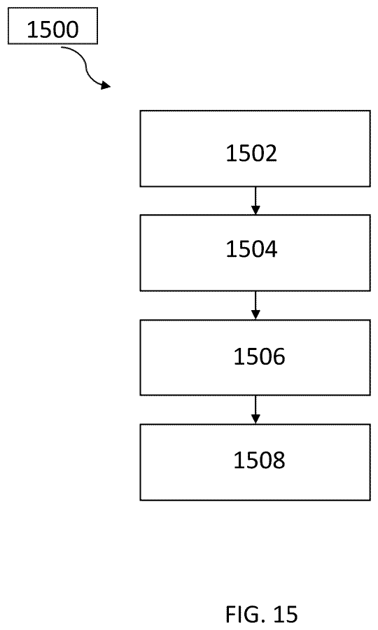

FIG. 15 illustrates a method (1500) for forecasting an observable using a quantum subsystem comprising Cooper Boxes in accordance with an exemplary embodiment of the present invention. The method (1500) comprises the following steps: (a) generating (1502) a series of physical controls, controlled by a series of electrode voltage, through an artificial neural network within a classical subsystem, configured for interaction with a quantum sub-system comprising of a series of Josephson Junction islands (Cooper boxes) arranged in a two-dimensional grid or honeycomb pattern, separated by thin layers insulator, such that tunneling of Cooper pairs is enabled between the islands, and connected externally to variable sources of voltage and/or pairwise through tunable capacitors to form an interconnected quantum network; (b) measuring (1504) the generalized forces exerted by the controls on the quantum sub-system, wherein the generalized forces are measured as induced charges on each as induced charges on each island; (c) adjusting (1506) the controls, through the ANN, in order to lower energy of the quantum sub-system with respect to a training data set, while maintaining a constant curvature of the energy with respect to an input data set; and (d) forecasting (1508) a value of a missing data in the data set by computing a value of the missing data that lowers the energy of the quantum sub-system.

A superconducting slab is cut into Cooper boxes separated by thin layer of semiconductor in a honeycomb pattern. The semiconductor resistance, hence tunneling coupling between Cooper boxes, can be controlled by voltage applied to the semiconductor. Cooper boxes are connected pairwise through adjustable capacitors and have an external voltage applied. The resulting Hamiltonian has the form:

$$\hat{H} ( \{ {d}_{i} \} ) = {\sum }_{jk} {J}_{jk} cos ( {\hat{ϕ}}_{k} - {\hat{ϕ}}_{j} ) + {e}^{2} \frac{{( {\hat{n}}_{k} - {\hat{n}}_{j} )}^{2}}{2 {C}_{jk} ( \{ {d}_{i} \} )} + {\sum }_{k} {eV}_{k}^{ext} ( \{ {d}_{i} \} ) {\hat{n}}_{k}$$

Where nⱼ is the number of Cooper pairs on j-th island, and ϕⱼ is the phase, while:

[\hat{n}ⱼ, \hat{ϕ}ⱼ]=i

Hilbert space data encoding: In one example, a joint probability distribution of K observables, each spanning a set of M possible values. For example, 100 binary observables would correspond to K=100 and M=2. The joint probability distribution of these outcomes has O(M^{K}) entries, i.e., grows exponentially with the number of observables. Instead, a Hilbert state model with dimensionality N≥M is used, where each observable corresponds to a Hermitian operator on this Hilbert space Aₖ, 1≤k≤K. The complexity of this representation is O(KN²). Thus, an HSM formulation allows to grow the number of variables defining the joint probability distribution only linearly in the number of observables. The present invention is particularly interested in the scenario of K>>N.

Observables as operators: Each observable Ax is represented by a Hermitian operator and its spectral decomposition:

Âₖ=UₖSₖU^{†}k

Where U is unitary and Sₖ is the diagonal matrix of real valued eigenvalues {aₖⁱ}, 1≤i≤N, which represent potential values of the observable corresponding to the operator A∧. The state is given by a complex valued vector in Hilbert space (wave function), Ψᵢ, such that the probability of measurement k being sₖⁱ is given by |U^{†}Ψ|². The price users pay for this parsimonious representation is that, generally speaking, as is the case in quantum mechanics, measurements become mutually incompatible, meaning that a sharp measurement of operator A and a sharp measurement of operator B are not possible at the same time, unless those operators commute [A, B]=0. According to the quantum cognition theory, this is precisely the source of ubiquitous logical fallacies. In quantum mechanics, the fact that a pair of non-commutative operators cannot be measured sharply simultaneously leads to Heisenberg Uncertainty Principle. Thus, as the operator of position x and operator of momentum p are mutually non-commutative [x, p]≠0, the uncertainties of simultaneous measurements of position Δx and momentum Δp obey the inequality:

Given a non-sharp measurement of x˜x0 and p˜p0, the lower bound of h/2 is achieved in the so-called wave-packet state, which corresponds to Gaussian distributions for both the position:

$$ψ ( x ) = \frac{1}{{π}^{\frac{1}{4}} {σ}^{\frac{1}{2}}} exp ( - \frac{{( x - {x}_{0} )}^{2}}{2 {σ}^{2}} + \frac{{ip}_{0} x}{ℏ} )$$

And momentum:

$$ϕ ( p ) = \frac{{σ}^{\frac{1}{2}}}{{π}^{\frac{1}{4}}} exp ( - {σ}^{2} \frac{{( p - {p}_{0} )}^{2}}{2} - \frac{{ix}_{0} p}{ℏ} )$$

Generalized wave-packet state Now, in another example, a data point {xₖ} corresponds to measurements of operators Aₖ. There is no state Ψ that corresponds to a sharp measurement, giving rise to {xₖ}. Instead, the present invention introduces the generalized wavepacket (GWP) state Ψ₀ that corresponds to the ground state of the following “error” Hamiltonian:

$$\hat{H} ( \{ {x}_{k} \} ) = {\sum }_{k}^{K} \frac{1}{2 {σ}_{k}^{2}} {( {x}_{k} \hat{I} - {\hat{A}}_{k} )}^{2}$$

Where I is the identity operator. Here σₖ² corresponds to some measure of error tolerance with regard to each observable. This error Hamiltonian generates an error of a fuzzy measurement for a given state Ψ and a given data point:

$$E ( \{ {x}_{k} \} , ψ ) = {ψ}^{*} \hat{H} ( \{ {x}_{k} \} ) ψ$$

As Ψ₀ minimizes this error, this represents the closest approximation to a given data point {yₖ}. In a sufficiently large Hilbert space, namely of size M^{K}, direct product of Hilbert spaces corresponding to all possible outcomes for each operator is embedded, all operators are made mutually commutative, to make all the measurements sharp. However, this leads to the problem of the curse of dimensionality and exponential growth of the representational space. As the dimensionality of the Hilbert space is reduced, representation becomes more parsimonious, and the fidelity of the representation is being sacrificed. Thus, data encoding in a wave-packet state represents a form of lossy compression. In this case, the particular form of the error Hamiltonian is not important. Any reasonable non-negative error function may be used, with only minor and obvious modifications to what follows. In particular, for binary variables xx, the cross-entropy form of error Hamiltonian can be implemented:

$$\hat{H} ( \{ {x}_{k} \} ) = {\sum }_{k}^{K} - {x}_{k} ln ( {\hat{P}}_{k} ) - ( 1 - {x}_{k} ) ln ( \hat{I} - {\hat{P}}_{k} )$$

Where the eigenvalues of Pₖ are constrained to be between 0 and 1.

Training: Given a set of training data points, {yₖ}ₜ, 1≤t≤T, the objective of training is to learn the operators Aₖ that minimize the aggregate error:

$${\hat{A}}_{k}^{0} = {arg min}_{{\hat{A}}_{k}} {\sum }_{t = 1}^{T} {E}_{t}$$

Training consists of alternating gradient descent steps with respect to U, and recalculating the ground state for each data point. If the measurement values are not fixed, gradient descent with respect to eigenvalues {sₖⁱ} is also included. Gradient descent may be done according to the stochastic gradient descent method using mini-batches of data points.

Gradient descent with respect to U: Starting with the previous estimate of Uₖ⁰ and given the set of coherent states Ψₜ for each data point t, the present invention looks to find an improved set of eigenvectors.

$${U}_{k} = {U}_{k}^{0} exp ( - {iX}_{k} )$$

Where Xₖ is a Hermitian operator representing incremental optimization step. The error Eₖ corresponding to the observation xₜ^{k} of k-th operator with is given by:

$${E}_{k} = {\sum }_{t} {ψ}_{i}^{*} {U}_{k}^{0} exp ( - {iX}_{k} ) {D}_{t}^{k} exp ( {iX}_{k} ) {U}_{k}^{0 †} {ψ}_{t}$$

Where Dₜ^{k} is a diagonal matrix with

$${( {D}_{t}^{k} )}^{j} = \frac{1}{2 {σ}_{k}^{2}} {( {x}_{t}^{k} - {a}_{k}^{j} )}^{2}$$

For small X, can be rewritten as:

$${E}_{k} \approx {E}_{k}^{0} + i {\sum }_{i} {ψ}_{t}^{*} {U}_{k}^{0} [ {D}_{t}^{k} , {X}_{k} ] {U}_{k}^{0 †} {ψ}_{t}$$

Taking the derivative with respect to matrix element Xₖ^{js}, the present invention obtains:

$$\frac{\partial {E}_{k}}{\partial {X}_{k}^{js}} = i {\sum }_{t} {( {ϕ}_{t}^{k} )}_{j}^{★} ( {( {D}_{t}^{k} )}^{j} - {( {D}_{t}^{k} )}^{s} ) {( {ϕ}_{t}^{k} )}_{s}$$

Where ϕₜ^{k}=Uₖ⁰Ψₜ.

Gradient with respect to eigenvalues. Similarly, if the present invention is dealing with discretized continuous observables, the set of discrete eigenvalues aₖ^{j} for each operator Aₖ is optimized. The gradient is then given by:

$$\frac{\partial {E}_{k}}{\partial {a}_{k}^{j}} = {\sum }_{t} {ψ}_{t}^{★} {U}_{k} diag ( \frac{{a}_{k}^{j} - {x}_{t}^{k}}{{σ}_{k}^{2}} ) {U}_{k}^{†} {ψ}_{t}$$

Forecasting Given an arbitrary set of inputs {xₖ} corresponding to a set of operators {Aₖ}, the present invention forecasts the probabilities of all possible measurements {bⱼ} of some arbitrary operator B=Vdiag(b)V^{†} according to the rules of quantum probabilities:

Where Ψ₀ is the coherent state corresponding to inputs {yₖ}. The expected value of a given observable is then given by:

[symbol]

(B)=Ψ₀*\hat{B}Ψ₀

In a preferred embodiment, the system is designed to infer the probability of an event by modeling a correlation between represented variables. It uses the encoded operator and the learned ground state, giving the system the ability to understand and predict correlations between different variables. In yet another embodiment, the generating module leverages a specific training paradigm involving Hilbert Space Expansion, Hilbert Space Pruning, and Hierarchical Learning. These techniques allow the system to manage exceptions, optimize learning, and train groups of operators both separately and together, enabling effective event forecasting based on quantum cognition principles. These steps underpin a novel quantum machine learning paradigm, where correlations in high-dimensional Hilbert spaces can capture complex relationships in the data. The modeling and inference involve quantum principles, providing an avenue for a logarithmic economy of representation and holistic inference, potentially yielding applications in finance, large language models, robotics, healthcare, and more.

The QOG Framework and the QOG Universal Learning Device form a cutting-edge quantum computing system that utilizes machine learning based on quantum probability theory, diverging from traditional models based on classical probability. This system comprises a processor and storage element that together execute encoded instructions to generate an operator in Hilbert Space with restricted parameterization. These operators are then manipulated to forecast events by establishing a correlation between observables. The system may also include mapping data points to physical controls and configuring a quantum subsystem annealed at low temperatures to measure and adjust forces, using back-propagation and gradient descent to train a model with predictive accuracy.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it is to be understood that references to anatomical structures may also assume image or image data corresponding to the structure. For instance, extracting a teeth arch translates to extracting the portion of the image wherein the teeth arch resides, and not the literal anatomical structure.

Some portions of embodiments disclosed are implemented as a program product for use with an embedded processor. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid state disk drive, etc.); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-accessible format and hence executable instructions. Also, programs are comprised of variables and data structures that either reside locally to the program or are found in memory or on storage devices. In addition, various programs described may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

The present invention and some of its advantages have been described in detail for some embodiments. It should also be understood that various changes, substitutions and alterations can be made herein without departing from the spirit and scope of the invention as defined by the appended claims. An embodiment of the invention may achieve multiple objectives, but not every embodiment falling within the scope of the attached claims will achieve every objective. Moreover, the scope of the present application is not intended to be limited to the particular embodiments of the process, machine, manufacture, and composition of matter, means, methods and steps described in the specification. A person having ordinary skill in the art will readily appreciate from the disclosure of the present invention that processes, machines, manufacture, compositions of matter, means, methods, or steps, presently existing or later to be developed are equivalent to, and fall within the scope of, what is claimed. Accordingly, the appended claims are intended to include within their scope such processes, machines, manufacture, compositions of matter, means, methods, or steps.

QOG generates an operator encoded from a set of observables, with modules that communicatively couple to an actor, which can be either an intelligent agent or any user interacting with the system. The system also includes classic computing systems 12, a quantum computing model 14, a processor, and a non-transitory storage element connected to the processor. Encoded instructions in the storage element, when executed, enable the system to generate a Hamiltonian operator, representing the observable in Hilbert Space with a restricted parametrization, and forecast an event based on a correlation between the represented observables. With respect to QOG, mediated by a quantum computing model, we achieve a precise and efficient method of event forecasting. In a preferred embodiment, as illustrated in FIG. 5, an exemplary system diagram of the Quantum Cognition Modeling Framework, also known as QOG, is designed to implement quantum cognition for event prediction. This system comprises a processor and a non-transitory storage element coupled to the processor. The storage element contains encoded instructions, which when executed by the processor, enable a sequence of operations facilitating event forecasting based on represented observables.

I/We claim:

1. A method for forecasting with a quantum subsystem using an artificial neural network or other form of mapping (ANN) comprising:
obtaining at least one data point and one or more stored parameters;
mapping the at least one data point to one or more physical controls using the artificial neural network based on the one or more stored parameters;
configuring the quantum subsystem at low temperatures based on the one or more physical controls;
measuring generalized forces exerted on the quantum subsystem by the one or more physical controls;
adjusting the one or more physical controls through the artificial neural network to lower energy of the quantum subsystem with respect to a training data set; and
forecasting a missing data value in the data set to lower the energy of the quantum subsystem.

2. The method according to claim 1, wherein obtaining at least one data point includes observing values inputted by the user, received through a networked system, or determined using a sensor network.

3. The method according to claim 1, wherein mapping the at least one data point to one or more physical controls using the ANN based on the one or more stored parameters implements digital to analog conversion.

4. The method according to claim 1, wherein mapping the at least one data point to one or more physical controls using the ANN based on the one or more stored parameters includes at least one of generating electrode voltage, capacitances of capacitors connecting Cooper boxes, electrode current, or any output required to control the quantum subsystem.

5. The method according to claim 1, wherein obtaining at least one data point and mapping to one or more physical controls includes generating a series of physical controls as outputs from observables as input data points using a parametrized mapping method.

6. The method according to claim 1, wherein mapping the at least one data point to one or more physical controls using the ANN based on the one or more stored parameters results in different output if the stored parameters inputted are changed.

7. The method according to claim 1, wherein configuring the quantum subsystem at low temperatures based on the one or more physical controls includes annealing of the quantum subsystem to a low temperature.

8. The method according to claim 1, wherein configuring the quantum subsystem at low temperatures based on the one or more physical controls includes inferring an Error Hamiltonian of the quantum subsystem.

9. The method according to claim 1, wherein forecasting a missing data value in the data set to lower the energy of the quantum subsystem implement gradient descent.

10. The method according to claim 9, wherein forecasting a missing data value in the data set to lower the energy of the quantum subsystem calculates the gradient with respect to missing data values by back-propagation (chain rule) of generalized forces.

11. The method according to claim 10, wherein forecasting a missing data value is assigning an expected value to a missing observable.

12. A method for training with a quantum subsystem, said system comprising:
obtaining a dataset and feeding at least one data point at a time to the artificial neural network;
mapping the dataset to one or more physical controls in the quantum subsystem using the artificial neural network;
configuring the quantum subsystem at low temperatures based on the one or more physical controls;
measuring generalized forces exerted on the quantum subsystem by the one or more physical controls;
adjusting the one or more physical controls through the artificial neural network to lower energy of the quantum subsystem; and
storing the adjusted parameters of the artificial neural network as a training data set to input into the quantum subsystem for forecasting.

13. A system for forecasting with a quantum subsystem, comprising:
at least one processor to receive and store a dataset;
any parametrized mapping method to map the dataset to one or more physical controls;
a digital-to-analog converter for translating digital output of the parametrized mapping method to a physical value of the one or more physical controls; and
a quantum subsystem interacting with the physical controls to forecast a missing data value.

14. The system according to claim 13, wherein the at least one processor receives the data set from a user or at least one connected device and stores the dataset into a memory device.

15. The system according to claim 14, wherein the memory device includes one or more registers to store the at least one data point of the data set for feeding into the artificial neural network.

16. The system according to claim 13, wherein the quantum subsystem to forecast a missing data value comprises a module to extract one or more parameters from dataset during a training iteration to store in the memory device.

17. A method for mapping dataset to one or more physical controls for interaction with a quantum subsystem using a gradient descent for forecasting comprising:
receiving a dataset to a parametrized mapping method;
mapping one datapoint at a time into the one or more physical controls in the form of at least one of electrode voltage, capacitances of capacitors connecting Cooper boxes, electrode current, or any output required to control the quantum subsystem; and
interacting with the physical controls to forecast a missing data value.

18. The method according to claim 17, the method further comprising:
measuring generalized forces exerted on the quantum subsystem by the one or more physical controls.

19. The method according to claim 17, the method further comprising:
adjusting the one or more physical controls through an artificial neural network to lower energy of the quantum subsystem.

20. The method according to claim 17, the method further comprising:
forecasting a missing data value in the data set to lower the energy of the quantum subsystem.

21. The method of claim 17, wherein the quantum subsystem is at least one of a quantum dot array, trapped ions, cooper boxes, or an optical lattice.
